(19) United States
(12) Patent Application Publication
(10) Pub. No.: US 2026/0039967 A1
(43) Pub. Date: Feb. 5, 2026

(54) METHODS AND SYSTEMS FOR REMOVING ARTEFACTS FROM AN IMAGE IN A MULTI-CAMERA DEVICE

(71) Applicant: SAMSUNG ELECTRONICS CO., LTD., Suwon-si (KR)

(72) Inventors: Soorajkumar BHAT, Bangalore (IN); Ashay G, Bangalore (IN); Ankit SHUKLA, Bangalore (IN); Abhijit DEY, Bangalore (IN)

(73) Assignee: SAMSUNG ELECTRONICS CO., LTD., Suwon-si (KR)

(21) Appl. No.: 19/292,444

(22) Filed: Aug. 6, 2025

Related U.S. Application Data
(63) Continuation of application No. PCT/KR2025/011498, filed on Aug. 1, 2025.

(30) Foreign Application Priority Data
Aug. 5, 2024 (IN) 202441059091

(51) Int. Cl. H04N 23/76; H04N 23/69; H04N 23/71

(52) U.S. Cl. CPC H04N 23/76; H04N 23/69; H04N 23/71

(57) ABSTRACT

A method for removing one or more artifacts from an image of a scene includes detecting a presence of a light beyond a predefined brightness in the scene; capturing a first image of the scene using a first Field of View (FOV) of a first camera of a multi-camera device, and a second image of the scene using a second FOV of a second camera of the multi-camera device; modifying the second image to generate an aligned second image by matching the first FOV with the second FOV; generating a masked binary image by subtracting the first image from the aligned second image, wherein the masked binary image indicates one or more locations of the one or more artifacts in the first image; and outputting a third image generated by removing the one or more artifacts from the first image using the aligned second image and the masked binary image.

### CROSS REFERENCE TO RELATED APPLICATIONS

This application is a by-pass continuation application of International Application No. PCT/KR2025/011498, filed on Aug. 1, 2025, which is based on and claims priority to Indian Patent Application No. 202441059091, filed on Aug. 5, 2024, in the Indian Patent Office, the disclosures of which are incorporated by reference herein in their entireties.

### BACKGROUND

### 1. Field

The present disclosure relates to the field of image artifact removal, and to a method and system artifact removal.

### 2. Description of Related Art

More and more services and additional functions are being provided via an electronic devices. To meet the needs of various users and raise use efficiency of electronic devices, communication service carriers or device manufacturers are jumping into competitions to develop electronic devices with differentiated and diversified functionalities. Accordingly, various functions that are provided through the electronic devices are evolving more and more.

The above information is presented as background information only to assist with an understanding of the disclosure. No determination has been made, and no assertion is made, as to whether any of the above might be applicable as prior art with regard to the disclosure.

### SUMMARY

Images and videos are preferable sources for users to consume content. The images and videos assist users in learning and understanding different types of content, components, or concepts. The images are captured by a device, for example, a mobile, a camera, a tab and the like. The users' experience depends upon the quality of images captured. It is desired that an image should reflect a real-world scene that it attempts to capture.

A captured image may have quality issues such as noise and artifacts. While noise may be related to a camera sensor, for example, artifacts are distortions created due to a lens of the camera and a source of light in the vicinity of the scene being captured. An artifact in an image captured by a camera device refers to anomalies or distortions that may not exist in the real scene. Examples of artifacts include noise, distortion, vignetting, chromatic aberration, motion blur, camera reflection, and the like.

Camera lens reflection or bubble artifacts are problems which may appear randomly in the captured images, particularly if there is bright object, light, or reflection near the scene being captured. The bubble artifact may appear randomly as a bubble (or circular) distortion which may have color and intensity distortions. The characteristics (size, and position, for example) of the bubble artifact may vary depending upon the light source (location, shape, intensity, consistency, and brightness), and the position of the camera, for example.

Bubble artifacts may be difficult to eliminate because the bubble may appear at a random location in the image irrespective of the location of the light source causing the artifact, and because the bubble artifact may only appear after the image has been captured. A preview frame on the display device of the camera may not show the bubble artifact until after the image has been captured. Even if the bubble would otherwise be visible in the preview, preventing the bubble from appearing in the preview may facilitate capturing an image with a composition where the bubble artifact will not appear later.

Addressing bubble artifacts may involve post-production editing of the images. Such attempts may be effort-intensive and dependent on individual human skill. An anti-reflective coating may be added to the lens of the camera, which may add additional costs, and such methodologies still may not eliminate bubble artifacts. Applying a coating such as a nano-scale coating may help mitigate a glare in the image but may not address the issue of bubble artifacts.

Attempts to edit the image in post-production may be performed to try to address bubble artifacts, but such techniques may be time consuming and may add additional costs. One such example of automated editing includes using Artificial Intelligence and Machine Learning (AI/ML) methods. Methods involving AI/ML may use huge amount of data and are calculation intensive. The AI/ML methods may require training before implementation, which in turn, may require large amounts of sample data for training. The occurrence of the bubble artifact may still randomly remain with respect to the location of the artifact in the image, for example. The training of the AI/ML model may therefore have limited efficacy due to difficulties in predicting the correct location of bubble occurrences in the image. Such AI/ML methods may also generate unrealistic or hallucinating results, such as colors and effects that are not present in the original image or the scene being captured. With the use of AI/ML methods, the use of photo-editing applications may still not be avoided. Apart from the cost and time for such applications, maintaining the structural and semantic consistency of other regions of the image being edited also poses numerous problems.

According to an aspect of the disclosure, a method for removing one or more artifacts from an image of a scene being captured using a multi-camera device includes detecting a presence of a light beyond a predefined brightness in the scene; capturing a first image of the scene using a first Field of View (FOV) of a first camera of the multi-camera device, and a second image of the scene using a second FOV of a second camera of the multi-camera device; modifying the second image to generate an aligned second image by matching the first FOV with the second FOV; generating a masked binary image by subtracting the first image from the aligned second image, wherein the masked binary image indicates one or more locations of the one or more artifacts in the first image; and outputting a third image generated by removing the one or more artifacts from the first image using the aligned second image and the masked binary image.

The detecting the presence of the light may include evaluating the light in one or more frames of the first camera, wherein the capturing the second image is performed in response to the evaluating the light.

The method may further include comparing FOVs of cameras of the multi-camera device; and selecting, from among the cameras, a camera having an FOV different from the first FOV as the second camera.

The modifying the second image to generate the aligned second image may include matching the first FOV with the second FOV based on at least one of a positional difference, in the multi-camera device, of the first camera and the second camera, or a relative optical zoom between the first camera and the second camera.

The generating the masked binary image may include generating a grayscale mask frame by splitting each of the first image and the second image into color channels; and calculating, for the color channels, a pixel-wise difference between corresponding color channels of the first image and the second image.

The generating the masked binary image may include applying dynamic thresholding to the grayscale mask frame based on an average lux value of the first image.

The removing the one or more artifacts may include applying the masked binary image to the aligned second image; extracting restoration data from the second image; and generating a restoration data mask based on the restoration data.

The removing the one or more artifacts may include applying the restoration data mask to the first image for restoring lost data in the first image, the lost data being data lost in the first image due to the one or more artifacts.

The outputting the third image may include outputting the third image via a display of the multi-camera device.

The selecting the second camera may include loading an FOV matching table including camera IDs and FOV values corresponding to the cameras; and selecting the second camera from among the cameras based on the camera IDs and the FOV values.

According to an aspect of the disclosure, a multi-camera device for removing one or more artifacts from an image of a scene being captured includes cameras; one or more processors; and memory storing instructions that, when executed by the one or more processors, cause the multi-camera device to detect a presence of a light beyond a predefined brightness in the scene; capture a first image of the scene using a first Field of View (FOV) of a first camera of the cameras; capture a second image of the scene using a second FOV of a second camera of the cameras; modify the second image to generate an aligned second image by matching the first FOV with the second FOV; generate a masked binary image by subtracting the first image from the aligned second image, wherein the masked binary image indicates one or more locations of one or more artifacts in the first image; and output a third image generated by removing the one or more artifacts from the first image using the aligned second image and the masked binary image.

The instructions, when executed by the one or more processors, may cause the multi-camera device to evaluate the light in one or more frames of the first camera, and the second image may be captured, via the second camera, in response to the light being evaluated.

The instructions, when executed by the one or more processors, may cause the multi-camera device to compare FOVs of the cameras; and select, from among the cameras, a camera having an FOV different from the first FOV as the second camera.

The instructions, when executed by the one or more processors, may cause the multi-camera device to match the first FOV with the second FOV based on at least one of a positional difference, in the multi-camera device, of the first camera and the second camera, and a relative optical zoom between the first camera and the second camera.

The instructions, when executed by the one or more processors, may cause the multi-camera device to generate the masked binary image based on generating a grayscale mask frame. The grayscale mask frame may be generated based on splitting each of the first image and the second image into color channels; and calculating, for the color channels, a pixel-wise difference between corresponding color channels of the first image and the aligned second image.

The instructions, when executed by the one or more processors, may cause the multi-camera device to apply a dynamic threshold to the grayscale mask frame based on an average lux value of the first image.

The instructions, when executed by the one or more processors, may cause the multi-camera device to apply the masked binary image to the aligned second image; extract restoration data from the second image; and generate a restoration data mask based on the restoration data.

The instructions, when executed by the one or more processors, may cause the multi-camera device to apply the restoration data mask to the first image for restoring lost data in the first image, the lost data being data lost in the first image due to the one or more artifacts.

The multi-camera device may further include a display, and the instructions, when executed by the one or more processors, may cause the multi-camera device to output the third image via the display.

According to an aspect of the disclosure, a non-transitory computer-readable recording medium having instructions recorded thereon, that, when executed by one or more processors, cause the one or more processors to detect a presence of a light beyond a predefined brightness in the scene; capture a first image of the scene using a first Field of View (FOV) of a first camera of the multi-camera device, and a second image of the scene using a second FOV of a second camera of the multi-camera device; modify the second image to generate an aligned second image by matching the first FOV with the second FOV; generate a masked binary image by subtracting the first image from the aligned second image, wherein the masked binary image indicates one or more locations of the one or more artifacts in the first image; and output a third image generated by removing the one or more artifacts from the first image using the aligned second image and the masked binary image.

According to an aspect of the disclosure, an electronic device comprising, a plurality of cameras, one or more processors, and memory storing instructions that, when executed by the one or more processors, cause the multi-camera device to, detect a light source in at least one image frame captured by at least one camera among the plurality of cameras of the electronic device, determine whether a brightness of the light source is more than a threshold value for the brightness, based on the brightness of the light source is more than the threshold value, capture a first image using a first Field of View (FOV) of a first camera among the plurality of cameras, and a second image using a second FOV of a second camera among the plurality of cameras, modify the second image to generate an aligned second image by matching the first FOV with the second FOV, generate a masked binary image by subtracting the first image from the aligned second image, wherein the masked binary image indicates one or more locations of one or more artifacts in the first image, remove the one or more artifacts from the first image by using the aligned second image and the masked binary image, and generate a third image that the one or more artifacts from the first image are removed, and output, through a display of the electronic device, the third image.

### BRIEF DESCRIPTION OF THE DRAWINGS

The above and other aspects, features, and advantages of certain embodiments are more apparent from the following description taken in conjunction with the accompanying drawings, in which:

FIG. 1A illustrates a phenomenon in which, in an electronic device including a plurality of cameras, lens reflection bubble artifacts occur at different locations depending on the cameras;

FIG. 1B illustrates a scenario depicting a real-world scene having a bright light source being captured using a multi-camera device;

FIG. 2 shows a few images as examples illustrating one or more bubble artifacts appearing in captured images as a result of presence of the bright light source;

FIG. 3A illustrates an environment comprising a system for removing artifacts from an image of a scene being captured using a multi-camera device, in accordance with an embodiment;

FIG. 3B shows examples of images of various scenes being captured by the multi-camera device, in accordance with an embodiment;

FIG. 3C shows another example of the image illustrating a difference between a glare of the light source (outside the scene) in the image and the one or more bubble artifacts appearing in the captured image as a result of the light source, in accordance with an embodiment;

FIG. 4A illustrates a system for removing artifacts from the image of the scene being captured using the multi-camera device, in accordance with an embodiment;

FIG. 4B illustrates a system for detection of the location of one or more bubble artifacts in the image in the multi-camera device, in accordance with an embodiment;

FIG. 4C illustrates a system for removing the bubble artifacts in the image in the multi-camera device, in accordance with an embodiment;

FIG. 5 illustrates the system for removing artifacts from the image of the scene being captured, in accordance with another embodiment;

FIG. 6A illustrates the working of a multi-camera trigger module (also referred to as MCLR Trigger), in accordance with an embodiment;

FIG. 6B illustrates the selecting of a reference camera, in accordance with an embodiment;

FIG. 6C is an exemplary Field of View (FOV) matching table, in accordance with an embodiment;

FIG. 6D illustrates a method used by the MCLR trigger, in accordance with an embodiment;

FIG. 6E illustrates the working of the dynamic thresholding engine of the MCLR trigger, in accordance with an embodiment;

FIG. 6F illustrates the working of luminance dynamic thresholding engine in accordance with an embodiment; FIG. 6G illustrates some examples of a frame of a first image and corresponding high luminance threshold images, in accordance with an embodiment;

FIG. 7 illustrates the working of a Spatial Alignment Transform (SAT) module of the system, in accordance with an embodiment;

FIG. 8A illustrates the working of a Lens Artifact Identification (L-RAID) module of the system, in accordance with an embodiment;

FIG. 8B illustrates the working of an ingestion engine and the L-RAID module, in accordance with an embodiment;

FIG. 8C illustrates the process flow of the L-RAID module, in accordance with an embodiment;

FIGS. 8D-8E illustrate an exemplary process flow for dynamic thresholding in the L-RAID module, in accordance with an embodiment;

FIG. 8F illustrates exemplary histograms for a masked binary image, in accordance with an embodiment;

FIG. 8G illustrates exemplary masked binary images at various threshold values, in accordance with an embodiment;

FIG. 8H illustrates the working of a delta engine configured for determining a threshold value for the dynamic threshold value, in accordance with an embodiment;

FIG. 9A illustrates the working of a Lens Artifact Removal (LENS-AR) module of the system, in accordance with an embodiment;

FIGS. 9B-9C illustrate the working of a pixel replication module, a pixel cloning module and a pixel healing module of a restoration engine of the LENS-AR module, in accordance with an embodiment;

FIG. 9D illustrates that an operation of pixel replication performed in the multi-camera device, in accordance with an embodiment;

FIG. 9E illustrates that an operation of pixel cloning performed in the multi-camera device, in accordance with an embodiment;

FIG. 9F illustrates that an operation of pixel healing performed in the multi-camera device, in accordance with an embodiment;

FIG. 9G illustrates overall procedures for removing lens artifact, in accordance with an embodiment;

FIG. 10A illustrates the reason why at least one image captured by the secondary camera cannot be directly output;

FIG. 10B and FIG. 10C illustrate lens reflection bubble artifact present in primary camera and secondary camera;

FIG. 11 illustrates the artifact formed is outside the FOV of the wide camera when the ultra-wide camera is the primary camera;

FIG. 12 is a flow chart illustrating a method for removing artifacts from an image of a scene being captured using a multi-camera device, in accordance with an embodiment;

FIG. 13 is a flowchart illustrating a method for detection of locations of one or more bubble artifacts in an image in a multi-camera device in accordance with another embodiment; and

FIG. 14 is a flowchart illustrating a method for removing bubble artifacts in an image in a multi-camera device, in accordance with an embodiment.

FIG. 15 is a block diagram illustrating an electronic device in a network environment, in accordance with an embodiment.

Artisans will appreciate that elements in the drawings are illustrated and may not have necessarily been drawn to scale. For example, the flow charts illustrate the method in terms of operations involved to help to improve understanding of aspects of the disclosure.

In terms of the construction of the device, one or more components of the device may have been represented in the drawings by symbols, and the drawings may show details that are pertinent to understanding the embodiments.

### DETAILED DESCRIPTION

The embodiments described in the disclosure, and the configurations shown in the drawings, are only examples of embodiments, and various modifications may be made without departing from the scope and spirit.

The term “some” or “one or more” as used herein is defined as “one”, “more than one”, or “all.” Accordingly, the terms “more than one,” “one or more” or “all” would all fall under the definition of “some” or “one or more”. The term “an embodiment”, “another embodiment”, “some embodiments”, or “in one or more embodiments” may refer to one embodiment or several embodiments, or all embodiments. Accordingly, the term “some embodiments” is defined as meaning “one embodiment, or more than one embodiment, or all embodiments.”

The terminology and structure employed herein are for describing, teaching, and illuminating some embodiments and their features and elements and do not limit, restrict, or reduce the spirit and scope of the claims or their equivalents. The phrase “exemplary” may refer to an example.

Any terms used herein such as but not limited to “includes,” “comprises,” “has,” “consists,” “have” and grammatical variants thereof do not specify an exact limitation or restriction and certainly do not exclude the addition of one or more features or elements, unless otherwise stated, unless otherwise stated with language indicating as such.

A feature or element may be referred to as “one or more features”, “one or more elements”, “at least one feature”, or “at least one element,” and the use of the terms “one or more” or “at least one” feature or element does not necessarily preclude there being none of that feature or element unless otherwise specified by language indicating as such.

All terms used herein may be taken to have the same meaning as commonly understood by one having ordinary skill in the art unless otherwise indicated.

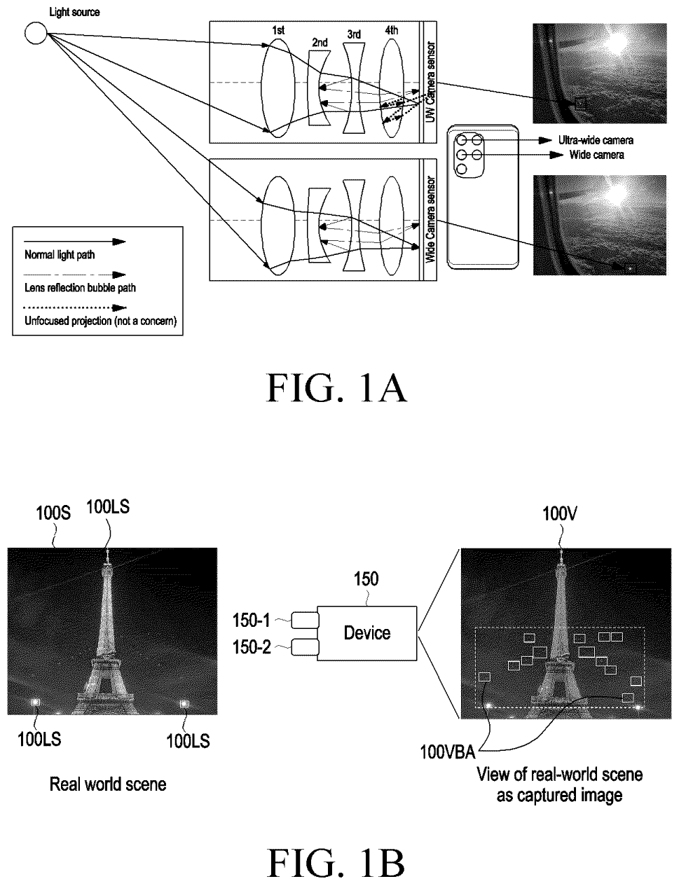

FIG. 1A illustrates a phenomenon in which, in an electronic device including a plurality of cameras, lens reflection bubble artifacts occur at different locations depending on the cameras.

Referring to FIG. 1A, the locations of lens reflection bubble artifacts in a plurality of cameras (e.g., two cameras) are different from each other because the physical locations of the cameras included in the electronic device are different from each other. As illustrated in FIG. 1A, the reflection angles of the lenses that cause lens reflection bubble artifacts in the frame are at different locations due to the difference in the positions of the cameras. The internal reflection can be from any lens based on an angle of reflection of light input to the lens.

FIG. 1B illustrates a scenario depicting a real-world scene 100S being captured using a multi-camera device 150. The real-world scene 100S may have a bright light source 100LS in the vicinity. The real-world scene 100S may be captured in the form of images 110V. The images 110V may be of varying quality. The images 110V may have one or more bubble artifacts 100VBA.

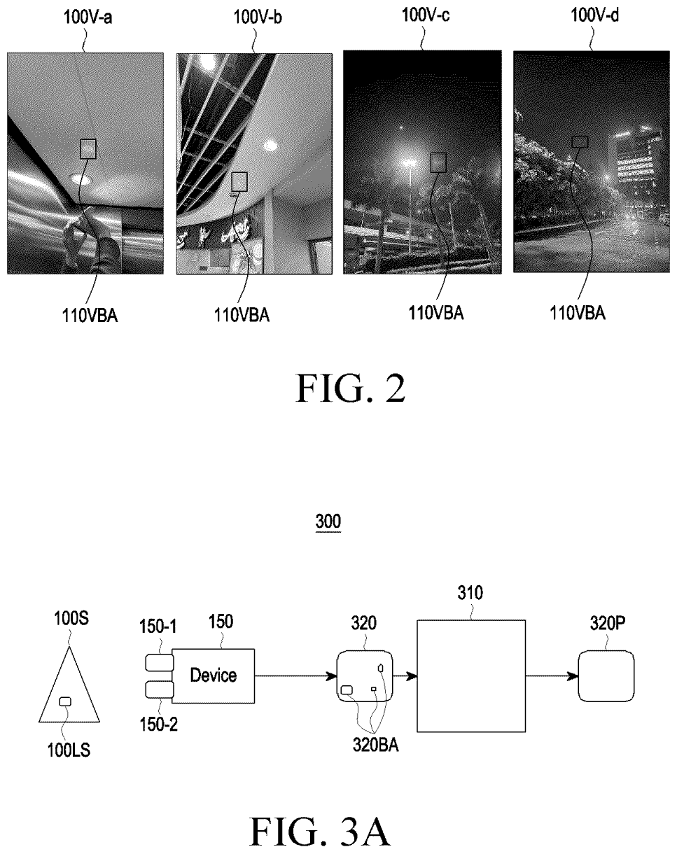

FIG. 2 shows a few images (100V-a-d) as examples illustrating the one or more bubble artifacts 100VBA appearing in the images 100V as a result of presence of the bright light source 100LS in the vicinity of the scene 100S. Each of the images 100V-a, 100V-b, 100V-c, and 100V-d has one or more bubble artifacts 100VBA.

Embodiments will be described below in detail with reference to the accompanying drawings.

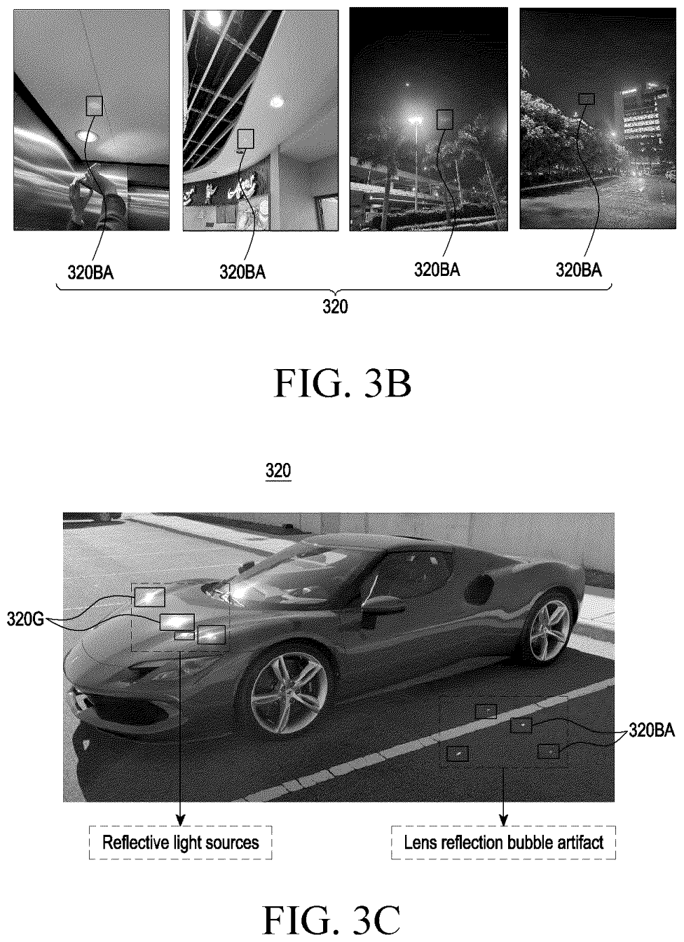

FIG. 3A illustrates an environment 300 comprising a system 310 for removing artifacts from an image 320 of the scene 100S being captured (e.g., obtained) using a multi-camera device 150 (interchangeably referred herein as the device 150), in accordance with an embodiment. The system 310 is communicably coupled with the device 150 for rendering the scene 100S in the form of images or videos. In an embodiment the device 150 has two cameras, a camera 150-1 and a camera 150-2.

In one or more embodiments, the system 310 and the device 150 are integrated into one device. Hardware components described herein in connection with the system 310 may be included in the device 150, and hardware components described herein in connection with the device 150 may be included in other components of the system 310.

In an embodiment, the system 310 removes the artifact 320BA even before a preview of the scene 100S is generated by the device 150. As a result the user may not see the bubble artifact. The bubble artifact 320BA may be detected and removed from the image by the system 310 before the user would otherwise be aware of the artifact.

The scene 100S may have a bright spot. The bright spot may be within a frame being captured of the scene 100S. The bright spot may be a source of light or an object reflecting light from the source of light. The bright source has luminance higher than an average luminance of the scene 100S. As a result, the image 320 of the scene may have one or more bubble artifacts 320BA. The bubble artifacts 320BA may appear at random locations in the image 320 being captured.

FIG. 3B shows examples of images 320 of various scenes 100-S being captured by the multi-camera device 150, in accordance with an embodiment. The images 320 have one or more bubble artifacts 320BA. FIG. 3C shows another example of the image 320 illustrating a difference between a glare 320G of the light source 100LS (outside the scene 100-S) in the image 320 and the bubble artifacts 320BA appearing in the captured image 320 as a result of the light source 100LS.

In various embodiments, the multi-camera device 150 (herein interchangeably referred to as the device 150) may be a smartphone, a camera, or any other electronic device with more than one camera compatible with capturing or recording images, video, for example, of the scene 100S (the real-world scene), without departing from the scope.

In such embodiments, the device 150 may include multiple layers, for example, an application layer, a file system layer, for example The application layer may include a video player application, a gallery application, or a camera application, without departing from the scope. The file system layer may include a file reader, a CoDec, a frame data, and a file writer. The file reader may be configured to read a video recorded by the application layer. The CoDec detects/checks a format of the recorded video (file) and also checks coder-decoder part of the format of the file. The frame data is prepared/formed by the CoDec for rendering a plurality of frames associated with the video on the display of the device 150.

Referring again to FIG. 3A, when the image 320 of the real-world scene 100S is being captured, the system 310 may be configured for removing artifacts such as lens reflection, bubble artifacts and the like, from the image 320 and generate a processed image 320P which is free of bubble artifacts. The constructional and operational details of the system 310 are explained in the subsequent paragraphs.

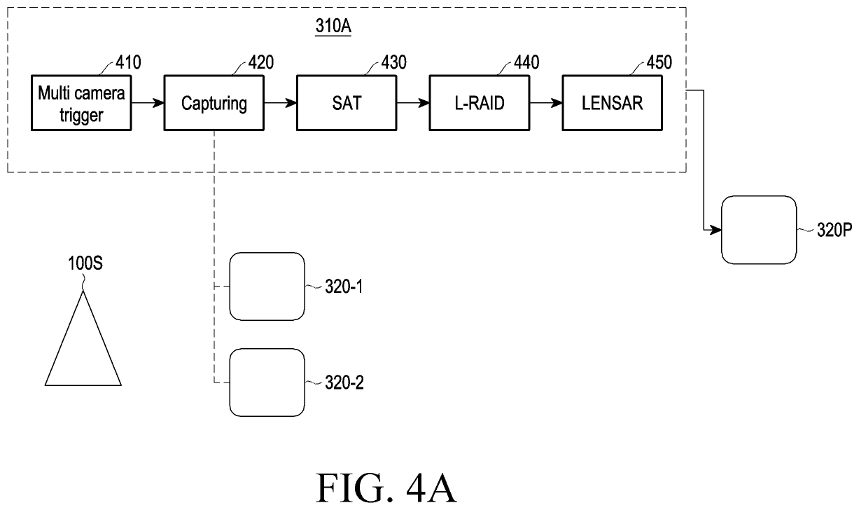

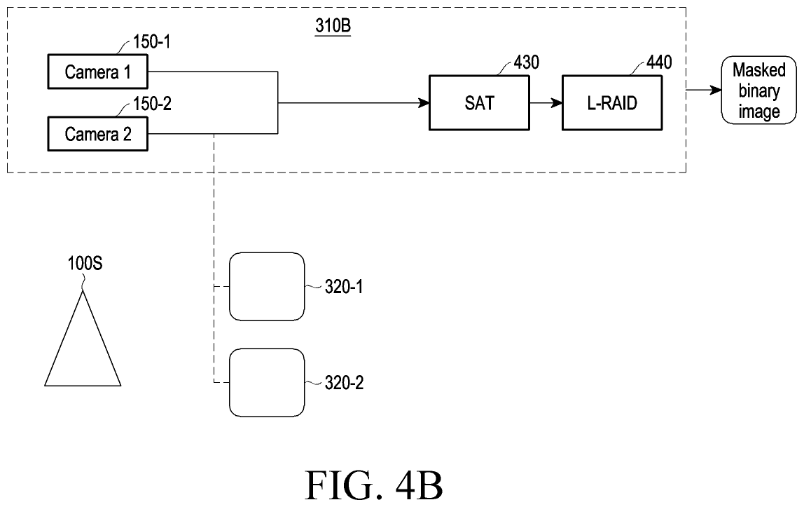

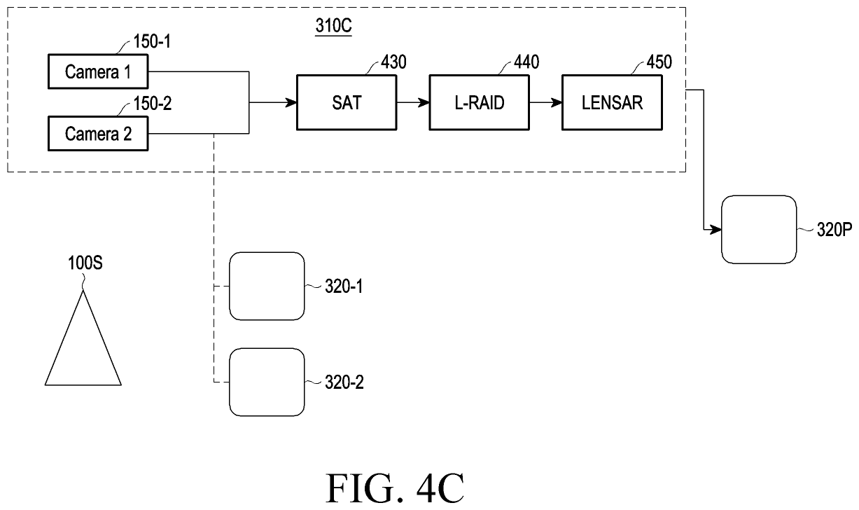

FIG. 4A illustrates the system 310 for removing artifacts from the image 320 of the scene 100S being captured using the device 150, in accordance with an embodiment. The system 310 includes a multi-camera trigger module 410, a capturing module 420, a Spatial Alignment Transform (SAT) module 430, a Lens Artifact Identification module 440 (also referred to as Lens Reflection bubble Artifact Identification module 440 or L-RAID module 440) and a Lens Artifact Removal (LENS-AR) module 450. The multi-camera trigger module 410 is configured for detecting a presence of a light beyond a predefined brightness in the scene being captured. The capturing module 420 is configured for capturing a first image 320-1 of the scene 100-S using a first Field of View (FOV) of the first camera 150-1 of the multi-camera device 150 and a second image 320-2 of the scene 100-S using a second FOV of the second camera 150-2 of the multi-camera device 150. The SAT module 430 is configured for modifying the second image 320-2 to generate an aligned second image by matching the first FOV with the second FOV. The L-RAID module 440 is configured for generating a masked binary image by subtracting the first image 320-1 from the aligned second image for indicating locations of one or more artifacts in the first image 320-1. Upon indication of location of the artifacts, the LENS-AR module 450 is configured for outputting a third image generated by removing the one or more artifacts from the first image 320-1 using the aligned second image and the masked binary image.

The system 310 may output the third image via a display of the system 310 or device 150.

The system 310 may store the third image in the memory 508 of the system 310.

The system 310 may transmit the third image to another device via the network interface.

FIG. 4B illustrates a system 310B for detection of the location of one or more bubble artifacts 320BA in the image 320 in the multi-camera device 150, in accordance with an embodiment. The system 310B includes the first camera 150-1, the second camera 150-2, the SAT module 430, and the L-RAID module 440. The first camera 150-1 is configured for capturing the first image 320-1. The second camera 150-2 is configured for capturing the second image 320-2. The first FOV is different from the second FOV. The SAT module 430 is configured for modifying the second image 320-2 to generate the aligned second image 320-2A by matching the first FOV with the second FOV.

Herein, in an embodiment, the L-RAID module 440 of the system 310B is configured for generating a grayscale mask frame by subtracting the first image 320-1 from the aligned second image 320-2A. Subsequently, the L-RAID module 440 of the system 310B is configured for converting the grayscale mask frame into the masked binary image by applying a threshold to the grayscale mask frame for detection of the locations of the one or more bubble artifacts.

FIG. 4C illustrates a system 310C for removing the bubble artifacts 320BA in the image 320 in the multi-camera device 150, in accordance with an embodiment. The system 310C includes the first camera 150-1, the second camera 150-2, the SAT module 430, the L-RAID module 440 and the LENS-AR module 450. The first camera 150-1 is configured for capturing the first image 320-1. The second camera 150-2 is configured for capturing the second image 320-2. The first FOV is different from the second FOV. The SAT module 430 is configured for modifying the second image 320-2 to generate the aligned second image 320-2A by matching the first FOV with the second FOV. In other words, the SAT module 430 is configured to match the first FOV of the first image 320-1 with the second FOV of the second image 320-2 for aligning the first image 320-1 and the second image 320-2 each other.

In an embodiment, the L-RAID module 440 of the system 310B is configured for generating a grayscale masked binary image by subtracting the first image 320-1 from the aligned second image 320-2A. The LENS-AR module 450 is configured for converting the masked binary image into an inverted masked binary image. Subsequently, the LENS-AR module 450 is configured for replicating pixels of the inverted masked binary image onto the first image 320-1. The LENS-AR module 450 is configured for cloning pixels having the bubble artifacts 320BA from the aligned second image 320-2A onto the masked binary image. Finally, the LENS-AR module 450 is configured for superimposing, onto the replicated pixels in the first image 320-1, the cloned pixels of the masked binary image to obtain an artifact free image 320P.

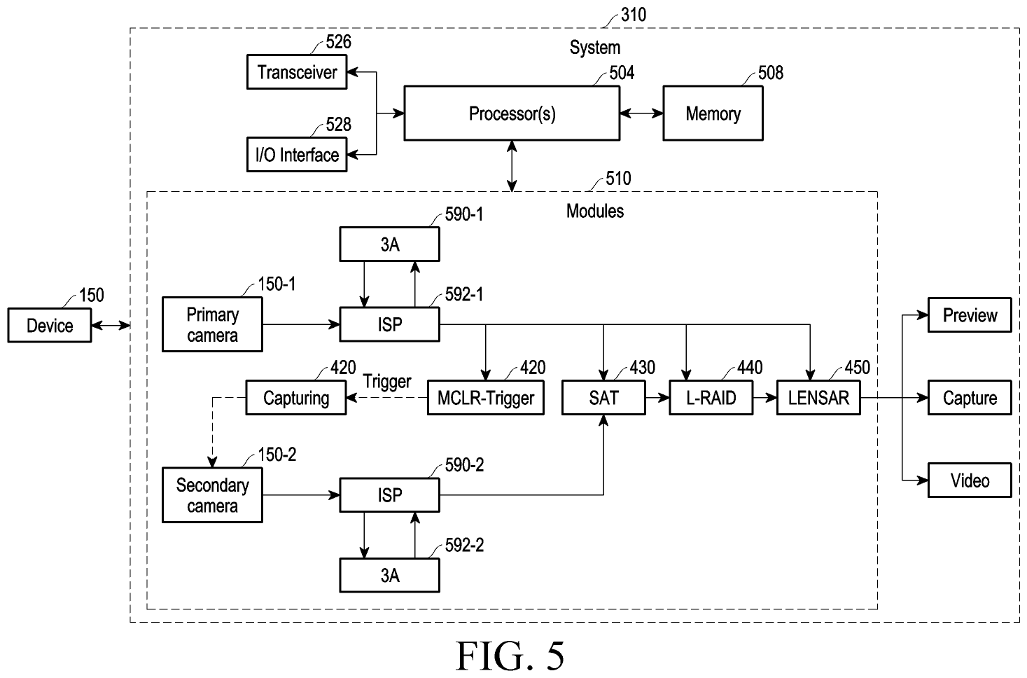

The working of each of these modules of the systems 310A, 310B and 310C is explained in conjunction with FIGS. 5-9.

FIG. 5 illustrates the system 310 for removing artifacts from the image 320-1 of the scene 100S, in accordance with another embodiment. The system 310 may include an Image Signal Processor (ISP) 590-1, an ISP 590-2, an Auto Focus Auto Exposure Auto White Balance (3A) module 592-1, and a 3A module 592-2.

In an embodiment, the system 310 includes a processor 504, a memory 508, a transceiver 526 and an I/O interface 528. The processor 504 may be disposed in communication with a communication network via a network interface. In an embodiment, the network interface may be the I/O interface 528. The network interface may connect to the communication network to enable the connection of the system 310 with the device 150. The network interface may employ connection protocols including, without limitation, direct connect, Ethernet (e.g., twisted pair 10/100/1000 Base T), transmission control protocol/internet protocol (TCP/IP), token ring, or IEEE 702.11a/b/g/n/x, for example. The communication network may include, without limitation, a direct interconnection, local area network (LAN), wide area network (WAN), wireless network (e.g., using Wireless Application Protocol), or the Internet, for example. Using the network interface and the communication network, the system 310 may communicate with other devices. The network interface may employ connection protocols including, but not limited to, direct connect, Ethernet (e.g., twisted pair 10/100/1000 Base T), transmission control protocol/internet protocol (TCP/IP), token ring, or IEEE 702.11a/b/g/n/x, for example.

The system 310 may include a display configured for displaying one or more of the images or videos described herein.

In some embodiments, the memory 508 may be communicatively coupled to the processor 504. The memory 508 may be configured to store data, and instructions executable by the processor 504. In one embodiment, the memory 508 may be provided within the device 150. In another embodiment, the memory 508 may be provided within the system 310 being remote from the device 150. In yet another embodiment, the memory 508 may communicate with the processor 504 via a bus within the system 310. In yet another embodiment, the memory 508 may be located remote from the processor 504 and may be in communication with the processor 504 via a network. The memory 508 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In one example, the memory 508 may include a cache or random-access memory for the processor 504. The memory 508 may be separate from the processor 504, such as a cache memory of a processor, the system memory, or other memory. The memory 508 may be an external storage device or database for storing data. The memory 508 may be operable to store instructions executable by the processor 504. The functions, acts, or tasks illustrated in the drawings or described herein may be performed by the programmed processor 504 for executing the instructions stored in the memory 508. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

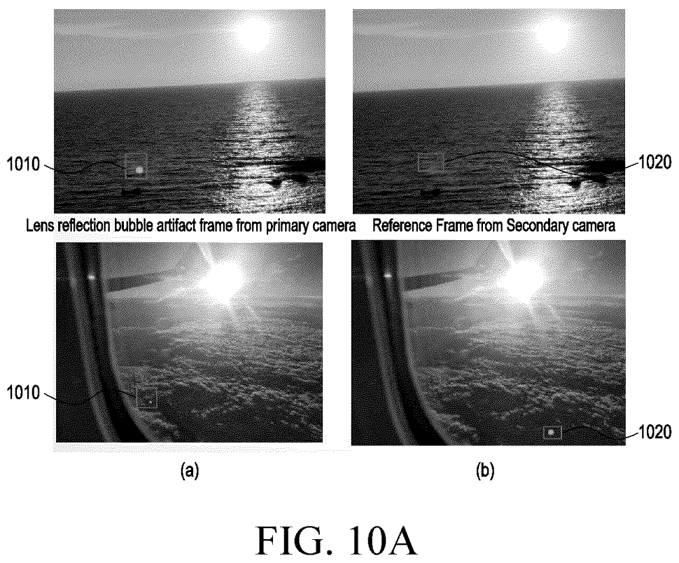

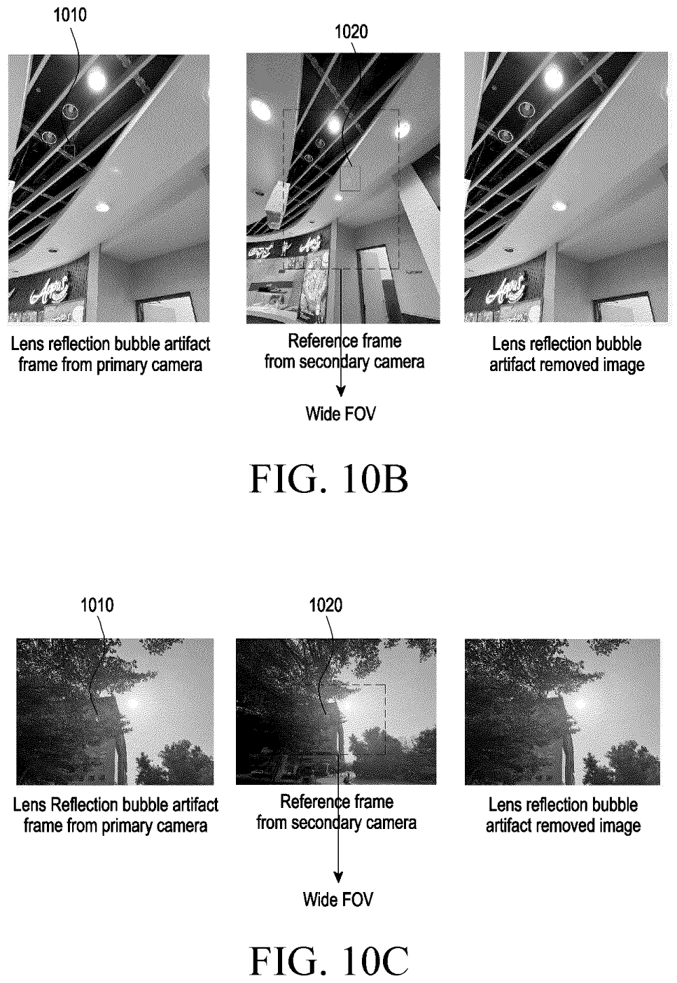

In some embodiments, the plurality of modules 510 may be included within the memory 508. The plurality of modules 510 may include a set of instructions that may be executed to cause the system 310, or the processor 504 of the system 310, to perform any one or more of the methods/processes disclosed herein. The plurality of modules 510 may be configured to perform the operations using the data stored in the database. For instance, the plurality of modules 510 may be configured to perform the operations disclosed in FIGS. 10-12.

In an embodiment, each of the plurality of modules 510 may be implemented using hardware outside the memory 508. The memory 508 may include an operating system for performing one or more tasks of the system 310, as performed by an operating system. Each of the modules 510 may be in communication with one another and the processor 504.

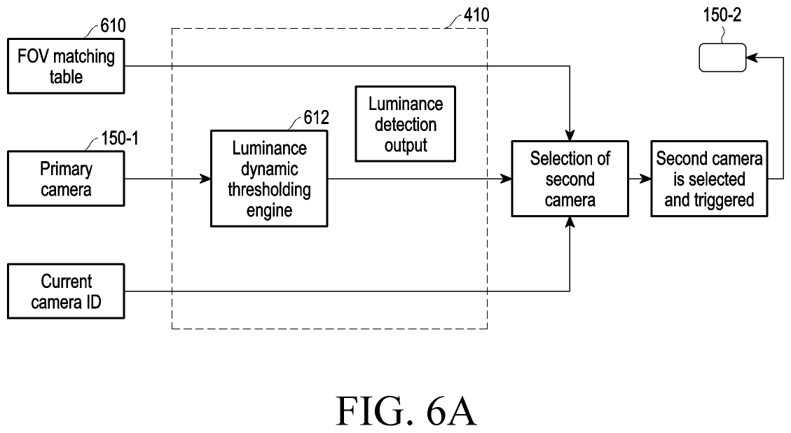

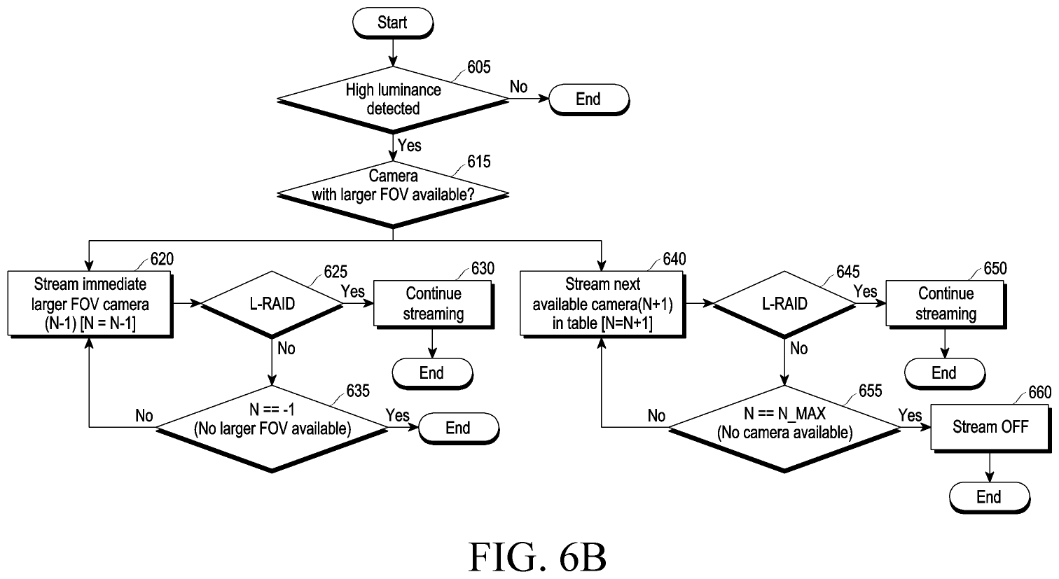

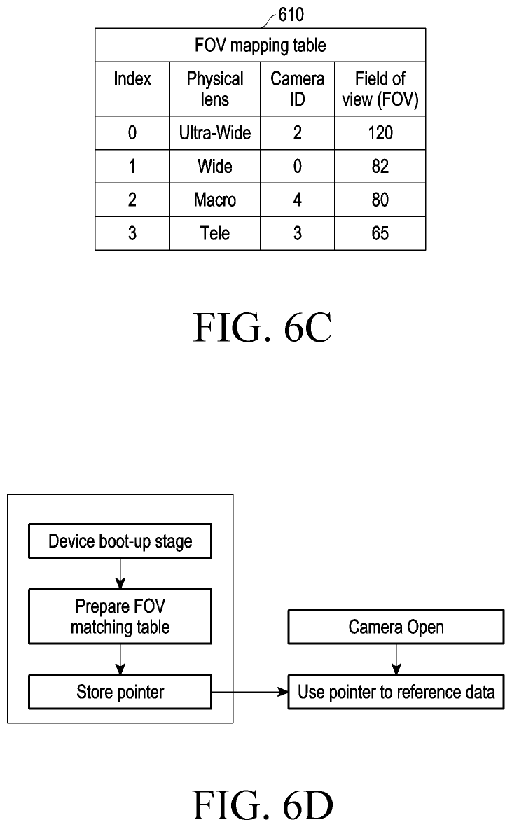

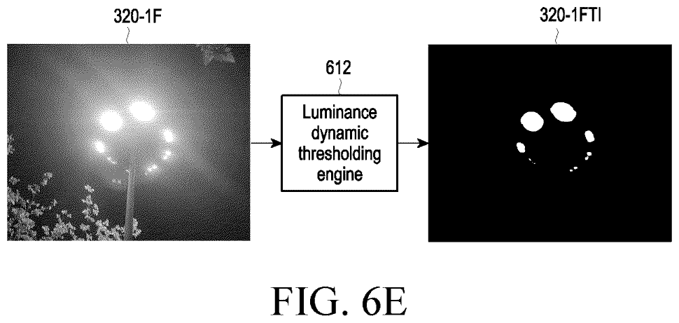

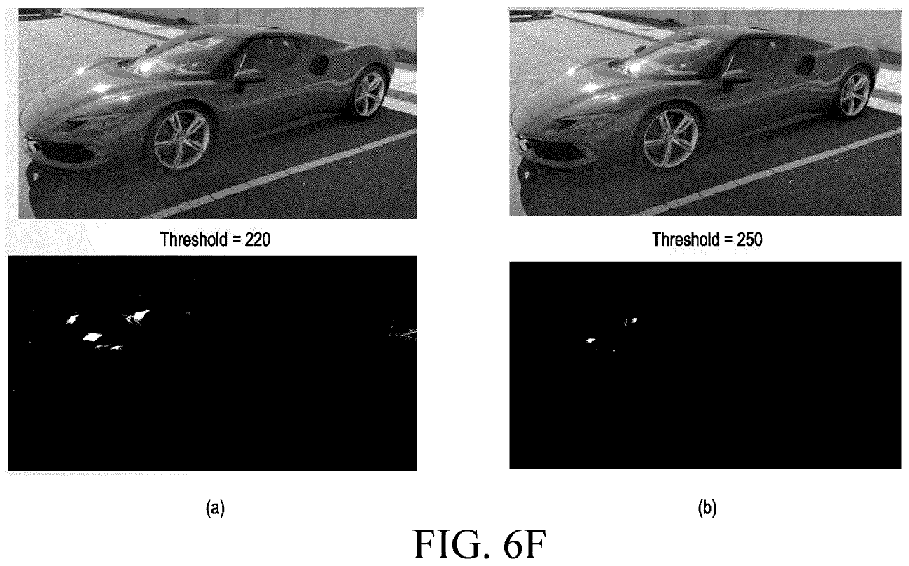

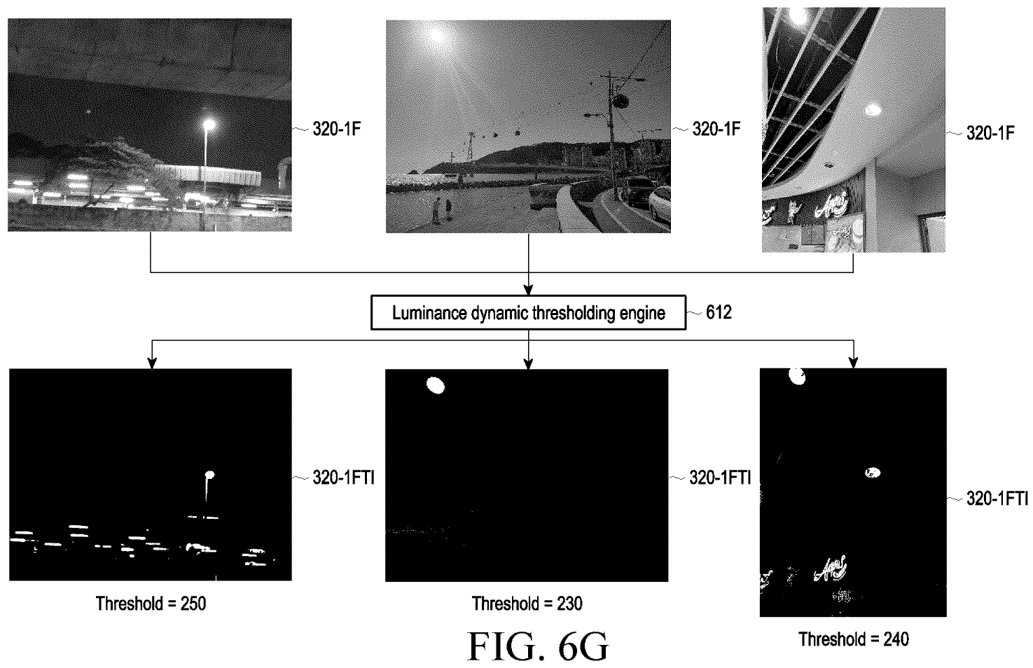

FIG. 6A illustrates a multi-camera trigger module 410 (also referred to as Multi-Camera Lens Reflection Trigger module 410 or MCLR trigger 410), in accordance with an embodiment. In an embodiment, the multi-camera trigger module 410 is configured for evaluating the light in the frames of the first camera 150-1. The MCLR trigger 410 includes a luminance dynamic thresholding engine 612 for evaluating the light in the frames of the first camera 150-1. The dynamic thresholding engine 612 compares the luminance of the light in the scene 100-S with a predefined threshold luminance value to evaluate the light in the frames of the camera 150-1. The device 150 may have a plurality of cameras. The first camera 150-1 may be a primary camera of the device 150. In response to the evaluation of the light by the MCLR trigger 410, the capturing module 420 is configured for capturing the second image 320-2, via the second camera 150-2.

The MCLR trigger 410 is configured for comparing FOVs of the plurality of cameras in the multi-camera device 150. Based upon the comparison, the MCLR trigger 410 selects a camera having an FOV different from the first FOV as the second camera 150-2. The MCLR trigger 410 uses an FOV matching table 610 to trigger the second camera 150-2 to capture the second image 320-2 of the scene 100-S. The FOV matching table 610 includes data such as an index for each camera number of the plurality of cameras in the device 150, and corresponding details of each camera such as the lens-type, a Camera ID and the FOV values. FIG. 6C is an exemplary FOV Matching Table.

For example, the selecting the second camera may include loading the FOV matching table 610, the FOV matching table 610 including camera IDs and FOV values corresponding to different cameras, and selecting the second camera from among the cameras based on the camera IDs and the FOV values.

FIG. 6B illustrates the selecting of a reference camera (e.g., a secondary camera), in accordance with an embodiment.

Referring to FIG. 6B, the multi-camera device according to one embodiment may determine, at operation 605, whether a source having high luminance is detected. The multi-camera device according to one embodiment may determine, at operation 615, whether a camera having a larger FOV than the currently shooting camera (e.g., the primary camera) is available. If a camera having a larger FOV than the currently shooting camera (e.g., the first secondary camera) is available, at operation 620, the multi-camera device according to one embodiment may perform immediate streaming (e.g., shooting and/or displaying a preview screen) using the camera having a larger FOV than the currently shooting camera. The multi-camera device according to one embodiment may continuously provide streaming using the first secondary camera if one or more artifacts are detected in the image acquired in operation 615 via L-RAID at operation 625, at operation 630. In this case, the multi-camera device according to one embodiment may process the image so that the properties of the image captured by the primary camera and the properties of the image acquired by the first secondary camera correspond to each other and then provide streaming. However, the multi-camera device according to one embodiment may directly output the image acquired by the first secondary camera without performing image processing if the properties of the image captured by the primary camera and the properties of the image acquired by the secondary camera correspond to each other. If it is determined through L-RAID that one or more artifacts are not included in the image acquired in operation 615, the multi-camera device according to one embodiment may determine whether a camera having a larger (e.g., wider) FOV than the secondary camera exists by decreasing the camera ID (N) in operation 635. The multi-camera device according to one embodiment may perform streaming using the secondary camera based on determining that there is no camera having a larger (e.g., wider) FOV than the secondary camera. In one embodiment, the multi-camera device may, if it is determined that a camera having a larger (e.g., wider) FOV than the secondary camera exists, perform some of the operations 625 to 635 again, continue streaming using a camera having a larger (e.g., wider) FOV than the secondary camera, or stop providing streaming by the first secondary camera

In one embodiment, the multi-camera device may, at operation 640, if a camera having a larger FOV than the currently shooting camera (e.g., the first secondary camera) is not available, provide streaming using the next available camera (e.g., the second secondary camera). In one embodiment, the multi-camera device may, at operation 645, if one or more artifacts are detected in the image acquired in operation 615 through L-RAID, provide streaming continuously using the second secondary camera at operation 650. In this case, the multi-camera device according to one embodiment may provide streaming after processing the image so that the properties of the image captured by the primary camera and the properties of the image acquired by the secondary camera correspond to each other. However, in one embodiment, the multi-camera device may directly output the image acquired by the secondary camera without performing image processing if the properties of the image captured by the primary camera and the properties of the image acquired by the secondary camera correspond to each other. Through L-RAID, if it is determined that one or more artifacts are not included in the image acquired in operation 615, the multi-camera device according to one embodiment may determine whether a camera having a smaller (e.g., narrower) FOV than the second secondary camera exists by increasing a camera ID (N) in operation 655. The multi-camera device according to one embodiment may perform streaming using the second secondary camera based on determining that there is no camera having a smaller (e.g., narrower) FOV than the second secondary camera. If it is determined that there is a camera having a smaller (e.g., narrower) FOV than the secondary camera, the multi-camera device according to one embodiment may stop providing streaming by the second secondary camera in operation 660.

FIG. 6D illustrates a method used by the MCLR trigger 410, in accordance with an embodiment. Once the device 150 boots, the FOV matching table 610 is generated. A pointer is stored to reference the data in the FOV matching table 610. When the first camera 150-1 is started, the MCLR trigger 410, in response to the evaluation of the luminance dynamic thresholding engine 612 of the light in the frames of the first camera 150-1, uses the pointer to reference the data in the FOV matching table 610.

In an embodiment, the FOV of the plurality of cameras in the device 150 may be calculated using the following exemplary code:

$$a = SENSOR\_INFO \_PHYSICAL \_SIZE . getWidth ( ) ;$$

$$b = SENSOR\_INFO \_PHYSICAL \_SIZE . getHeight ( ) ) ;$$

$$diagonal = Math . hypot ( a , b ) ;$$

$$focalLength = LENS\_INFO \_AVAILABLE \_FOCAL \_LENGTHS [ 0 ] ;$$

$$FOV ( radians ) = Math . atan ( diagnol / ( focalLength * 2 ) ) ;$$

$$FOV ( degrees ) = Math . toDegrees ( rad ) * 2$$

The math.hypot( ) method return the Euclidean norm. The Euclidean norm is the distance from the origin to the coordinates given. The math.a tan( ) static method returns the inverse tangent in radians of a number.

FIG. 6E illustrates the working of the luminance dynamic thresholding engine 612, in accordance with an embodiment. In an embodiment, an input to the luminance dynamic thresholding engine 612 is a frame 320-1F for the first image 320-1 captured by the first camera 150-1. The luminance dynamic thresholding engine 612 dynamically thresholds high luminance regions in the frame 320-1F of the first image 320-1 and outputs a high luminance threshold image 320-1FTI. Upon detection of the high luminance regions in the frame 320-1F of the first image 320, the MCLR trigger 410 uses a camera ID of the first camera 150-1 and the FOV matching table 610 for selection of the second camera 150-2.

The luminance dynamic thresholding engine 612 is configured for determining a pixel intensity level of the frame 320-1F. If the pixel intensity level is above a predefined pixel intensity value, the pixel and a corresponding object are considered having high luminance. The predefined value may depend upon the ambience and time of the day such as outdoor, indoor, daytime, night time and the like. For example, the scene 100-S of an outdoor scenario during daytime may have a higher value of luminance in the range of 240-250 pixels intensity value due to the presence of the Sun. The dynamic threshold may be kept at 220-225 pixel intensity value for such scenarios. The dynamic threshold may be kept at 240 pixel intensity value for indoor office scenarios. The dynamic threshold may be kept at 240 pixel intensity value for a night scenario.

FIG. 6F illustrates the working of luminance dynamic thresholding engine in accordance with an embodiment;

Referring to FIG. 6F, there is a case of lens reflection artifact which can also be caused by reflective light surfaces (e.g., occurring in outdoor scenes) which has luminance less than bright sun in outdoor scene. Outdoor scenes often have bright sun which is in the range of 240-250 pixel intensity values but in case of reflective light surfaces pixel intensity values are in 220 range. Therefore, the threshold may be in 220-225 range pixel intensity value.

FIG. 6G illustrates some examples of the frame 320-1F of the first image 320-1 and the corresponding high luminance threshold images 320-1FTI, in accordance with an embodiment. A dynamic threshold of 230, 240 and 250 may be used. The values of the dynamic threshold have been provided as examples. It may be apparent that the value of the dynamic threshold may be chosen depending upon the scene 100-S being captured.

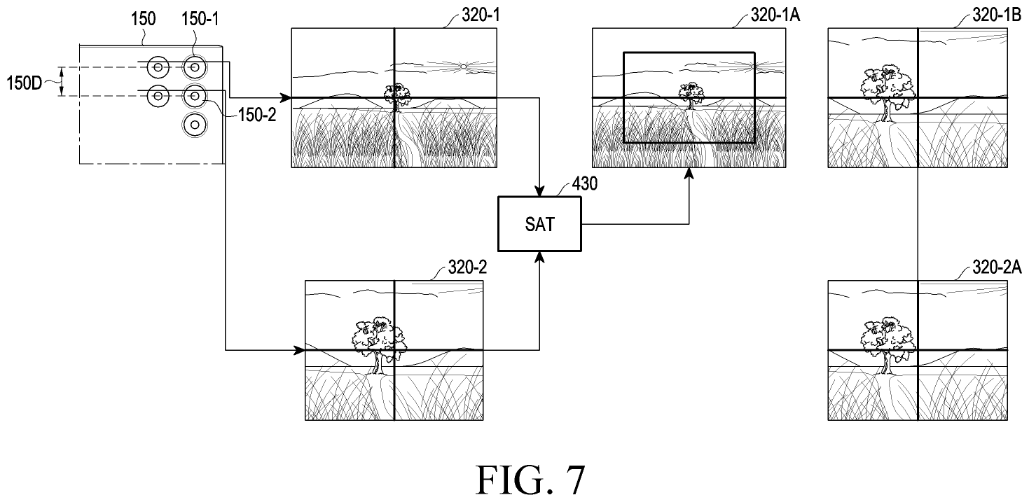

FIG. 7 illustrates the working of the SAT module 430, in accordance with an embodiment. In an embodiment, the SAT module 430 is configured for matching the first FOV with the second FOV based on a positional difference of the first camera 150-1 and the second camera 150-2 or a relative optical zoom between the first camera 150-1 and the second camera 150-2. The first camera 150-1 may be a primary camera of the device 150. The primary camera is one of the plurality of the cameras of the device 150 which is triggered first when the image 320 is to be captured. A distance of 150D exists between the first camera 150-1 and the second camera 150-2 in the device 150.

Due to the distance 150D, the FOVs of the first camera 150-1 and the second camera 150-2 are slightly different. In an embodiment, the first camera 150-1 may be an ultrawide camera and the second camera 150-2 may be a wide camera. It may be apparent that an operation of cropping may not accurately match a target FOV. For example, a mere center-cropping of the first image 320-1 of the first camera 150-1 will not result in an image that matches the FOV of the second camera 150-2. To address this issue, the SAT module 430 matches the first FOV with the second FOV based on the distance 150-D and adjusts the FOV of the first camera 150-1 to align with that of the second camera 150-2, thereby aligning the FOVs of the first image 320-1 and the second image 320-2.

In an embodiment, the SAT module 430 is configured for matching the first FOV with the second FOV based on a relative optical zoom between the first camera 150-1 and the second camera 150-2. A zoom ratio of the first camera 150-1 and the second camera 150-2 at default zoom is input to the SAT module 430 for re-calculating a crop value to be applied to the second image 320-2 to match the FOVs.

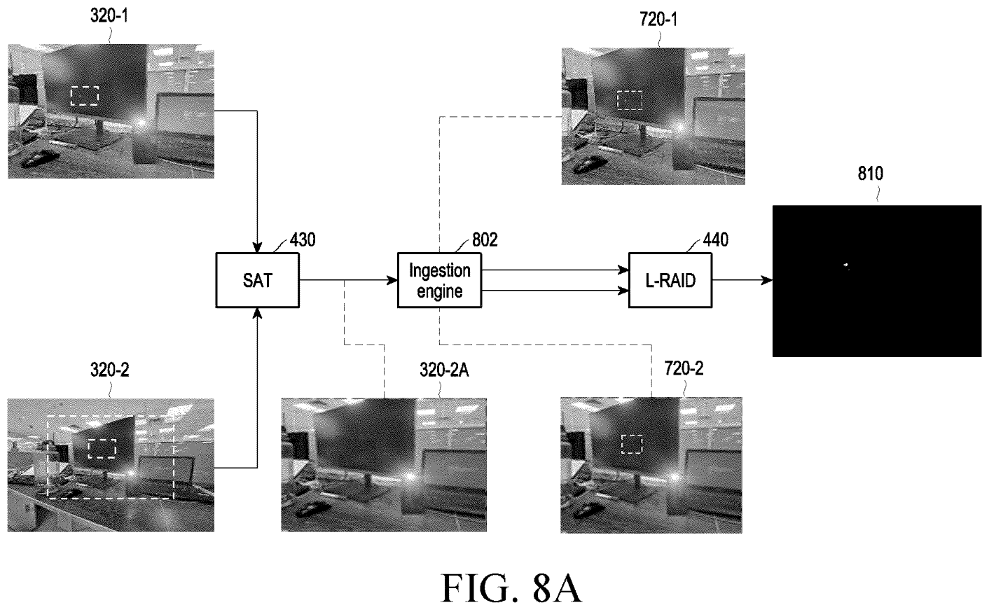

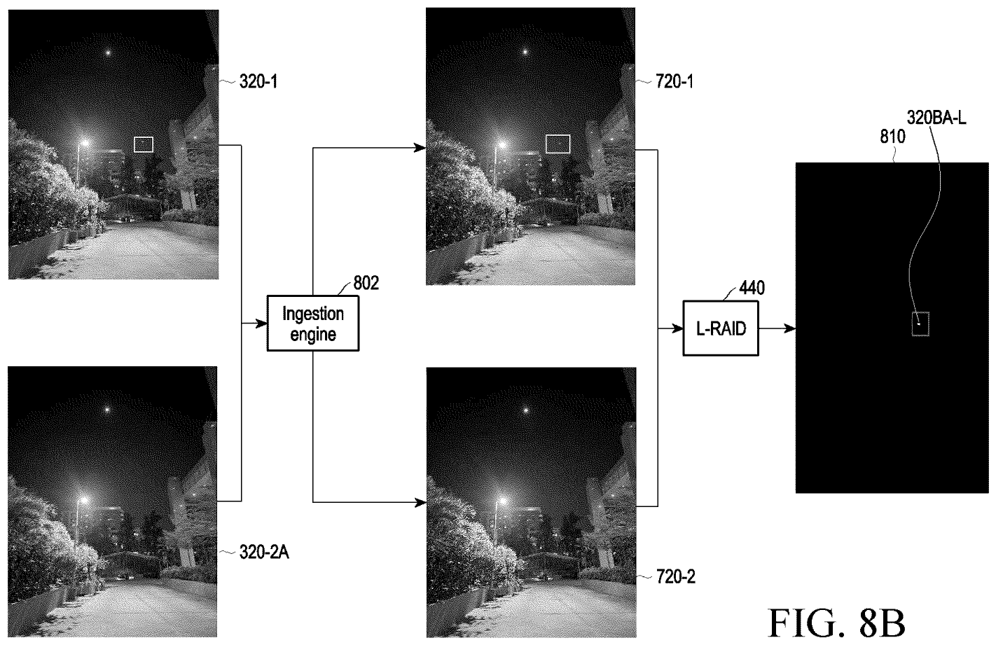

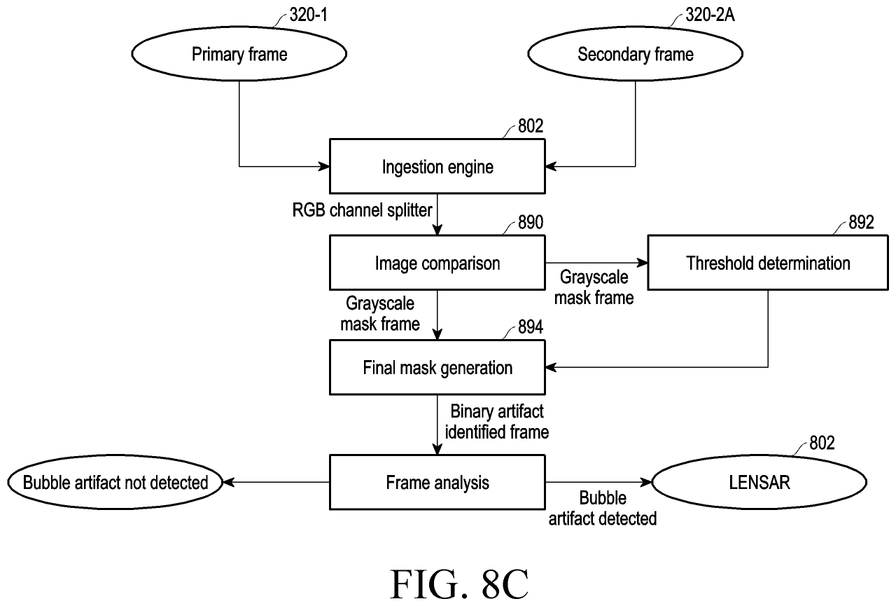

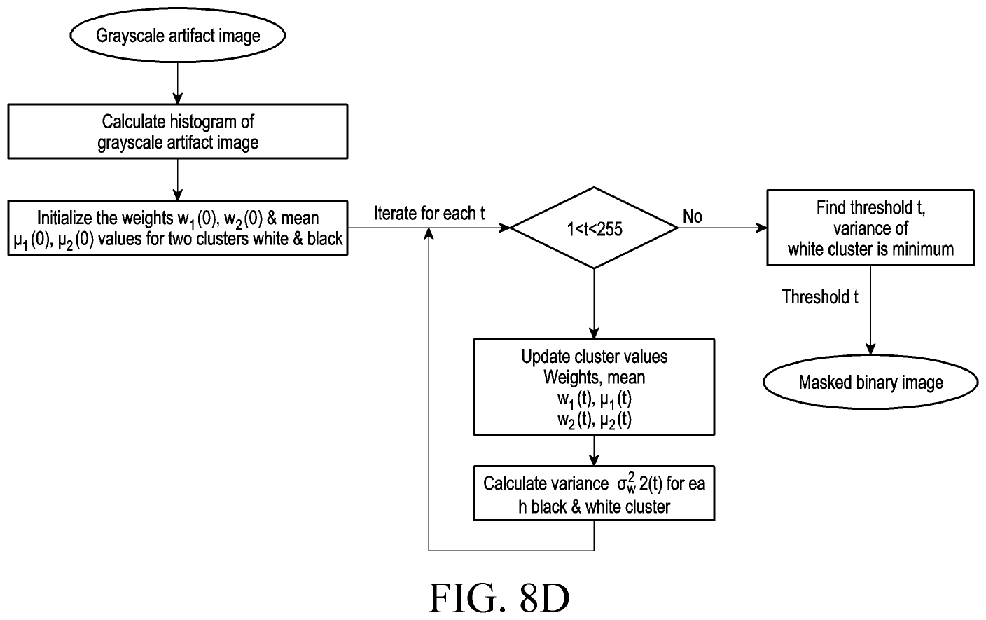

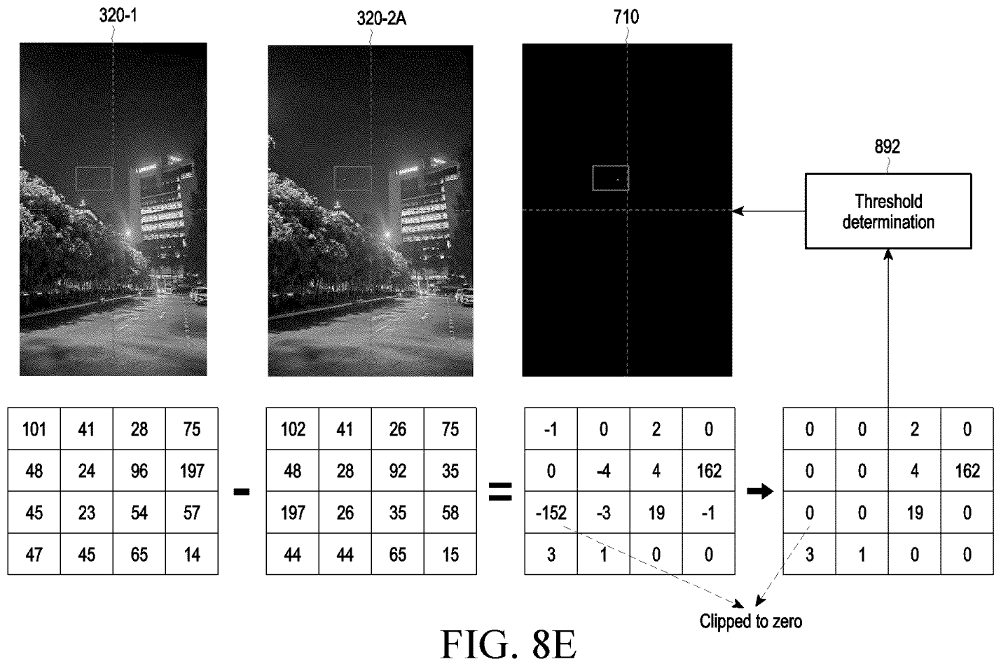

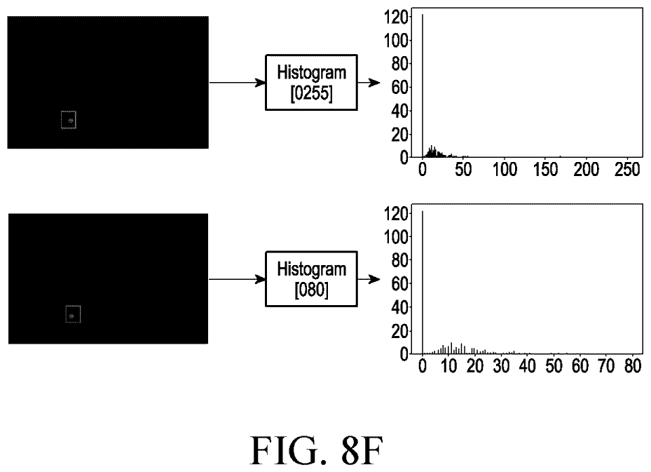

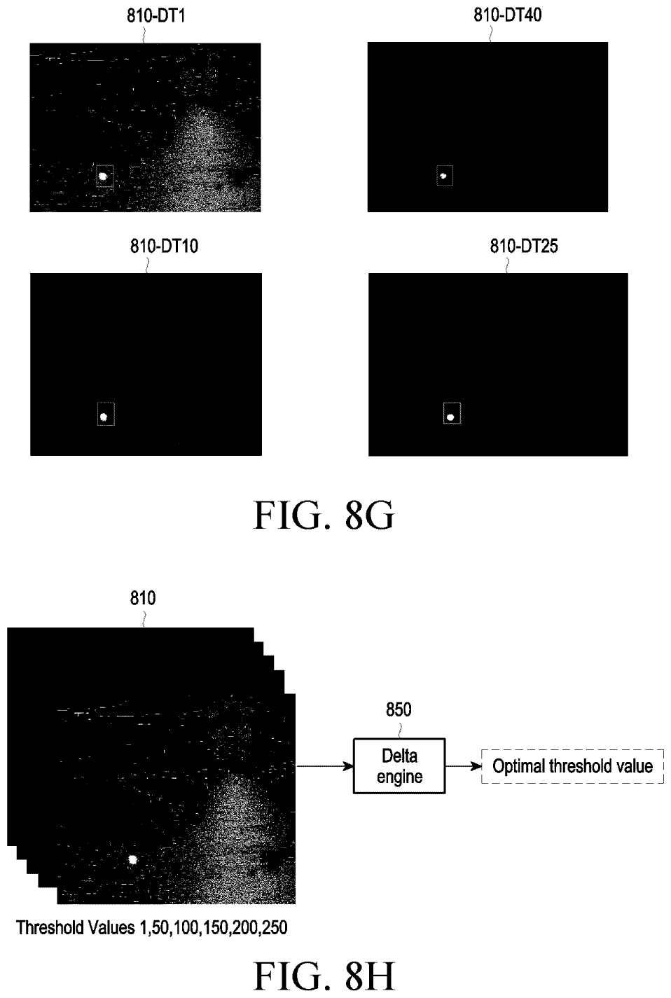

FIG. 8A illustrates the working of the L-RAID module 440, in accordance with an embodiment. There may be characteristic differences between the first image 320-1 and the second image 320-2 due to the different location, zoom level for example of the first camera 150-1 and the second camera 150-2. It may be appreciated that such characteristic differences may not allow accurate determination of the location of the bubble artifact 320BA in the first image 320-1. In an embodiment, the L-RAID module 440 is configured for splitting each of the first image 320-1 and the aligned second image 320-2A into a plurality of color channel frames and generating corresponding grayscale frames such as grayscale images 720-1 and 720-2 (shown in FIG. 8A). The corresponding grayscale images 720-1 and 720-2 also help in normalizing the varying intensities of lens reflections in the device 150.

In an embodiment, as shown in FIG. 8A, the system 310 includes an ingestion engine 802. The ingestion engine 802 is configured to split the first image 320-1 and the aligned second image 320-2A into the plurality of color channels such as a Red channel, a Green channel and the like. The first image 320-1 and the aligned second image 320-2A are input to the ingestion engine 802. The output from the ingestion engine 802 are an RGB (Red-Green-Blue) split-channel corresponding grayscale images 720-1 and 720-2. Subsequently, the grayscale images 720-1 and 720-2 are fed into the L-RAID module 440 to identify location of the bubble artifact 320BA in the first image 320-1. The L-RAID module 440 calculates, for each color channel, a pixel-wise difference between the corresponding color channels, that is the grayscale images 720-1 and 720-2. In an embodiment, the L-RAID module 440 is configured for using only one-color channel of the plurality of the corresponding color channels such as the red channel for calculating the pixel-wise difference.

FIG. 8B illustrates the working of the ingestion engine 802 and the L-RAID module 440, in accordance with an embodiment. The ingestion engine 802 converts the first image 320-1 having the bubble artifact 320BA and the aligned second image 320-2A into the corresponding grayscale images 720-1 and 720-2. The L-RAID module 440 generates the masked binary image 810 using the corresponding grayscale images 720-1 and 720-2. The masked binary image 810 has a location 320BA-L of the bubble artifact 320BA.

In an embodiment, the L-RAID module 440 is configured for generating a grayscale mask frame by subtracting the grayscale image 720-1 from the grayscale image 720-2 for indicating the locations 320BA-L of the bubble artifact 320BA in the first image 320-1. The L-RAID module 440, subsequently, converts the grayscale mask frame into the masked binary image 810.

FIG. 8C illustrates the process flow of the L-RAID module 440, in accordance with an embodiment. In an embodiment, the L-RAID module 440 includes an image comparison engine 890 configured for comparing the grayscale images 720-1 and 720-2 to generate the masked binary image 810. The location 320BA-L is white in the masked binary image 810 while all the other pixels are black. Despite the image comparison engine 890 distinguishing bubble pixels as white and other common pixels as black, the masked binary image 810 may use thresholding due to color intensity variations within the grayscale images 720-1 and 720-2.

In an embodiment, the L-RAID module 440 includes a dynamic thresholding engine 892 configured for applying dynamic thresholding to the grayscale mask frame for converting all differences to black so that the location 320BA-L of the bubble artifact 320BA is identified. The L-RAID module 440 further includes a final mask generator 894 configured for applying the dynamic thresholding to the grayscale mask frame to generate the masked binary image 810.

In an embodiment, the L-RAID module 440 is configured for applying the dynamic thresholding to the grayscale mask frame based on an average lux value of the first image 320-1 to generate the masked binary image 810.

FIGS. 8D-8E illustrate an exemplary process flow for the dynamic thresholding engine 892 and the final mask generator 894 of the L-RAID module 440, in accordance with an embodiment. As an example, following operations may be followed by the L-RAID module 440 for generating the masked binary image 810 from the corresponding grayscale images 720-1 and 720-2.

A histogram and an intensity-level probabilities of the distribution of pixels of the grayscale mask frame is calculated. Following operations may be followed:
Initialize wᵢ(0), μᵢ(0),
   where i is a cluster
Iterate over thresholds:
   t=0, . . . , max_intensity (255) values
Update the values of wᵢ,μᵢ
   where wᵢ is a probability and μ_i is a mean of cluster i
Compute two cluster variance value:

$${σ}_{w}^{2} ( t )$$

The histogram is separated into the two clusters, a white cluster and a black cluster with a predefined threshold as a result of minimizing the weighted variance of the two clusters denoted by:

$${σ}_{w}^{2} ( t ) .$$

$${σ}_{w}^{2} ( t ) = {w}_{1} ( t ) {σ}_{1}^{2} ( t ) + {w}_{2} ( t ) {σ}_{2}^{2} ( t )$$

Where:
w₁(t), w₂(t) are the probabilities of the two clusters separated by a threshold ‘t’ within the range 0-255.
A threshold ‘t’ is determined which minimizes the variance

$${σ}_{w}^{2} ( t )$$

value.

The L-RAID module 440 is configured for replacing the pixels in the grayscale mask frame into white for which the saturation is greater than ‘t’, otherwise into black. For generation of the masked binary image 810, the threshold is applied to the grayscale mask frame.

FIG. 8F illustrates exemplary histograms for the grayscale mask frame, in accordance with an embodiment. It may be appreciated from the exemplary histograms that a value for the threshold value may lie between 20 and 30.

FIG. 8G illustrates exemplary masked binary images (810-DT1, 810-DT2) at various threshold values, in accordance with an embodiment. A masked binary image 810-DT1 is at a dynamic threshold value of 1.0, a masked binary image 810-DT10 is at a dynamic threshold value of 10.0, a masked binary image 810-DT40 is at a dynamic threshold value of 40.0, and a masked binary image 810-DT25 is at a dynamic threshold value of 25.0.

FIG. 8H illustrates the working of a delta engine 850 configured for determining a threshold value for the dynamic threshold value, in accordance with an embodiment. In an embodiment, the system 310 includes the delta engine 850 for determining the threshold value.

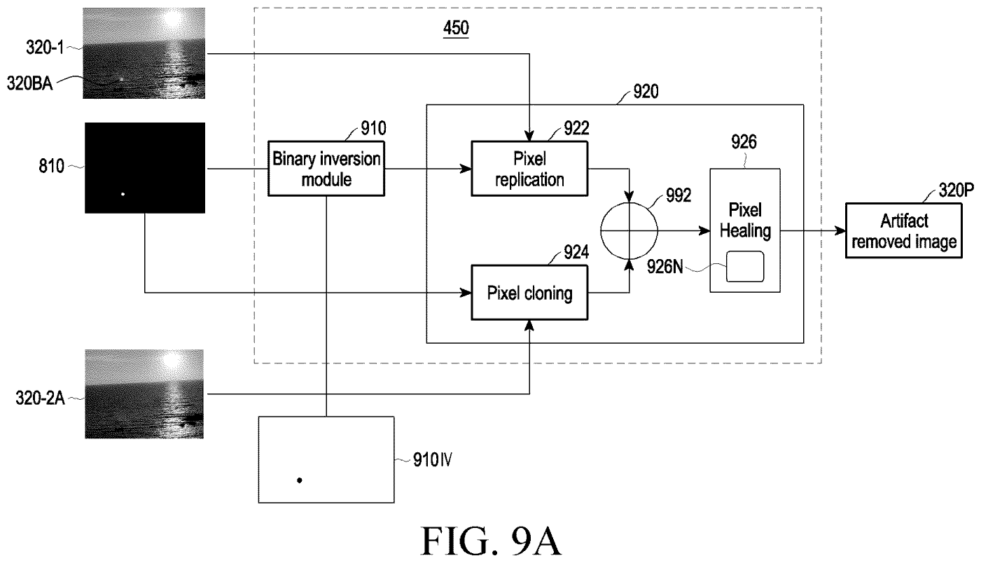

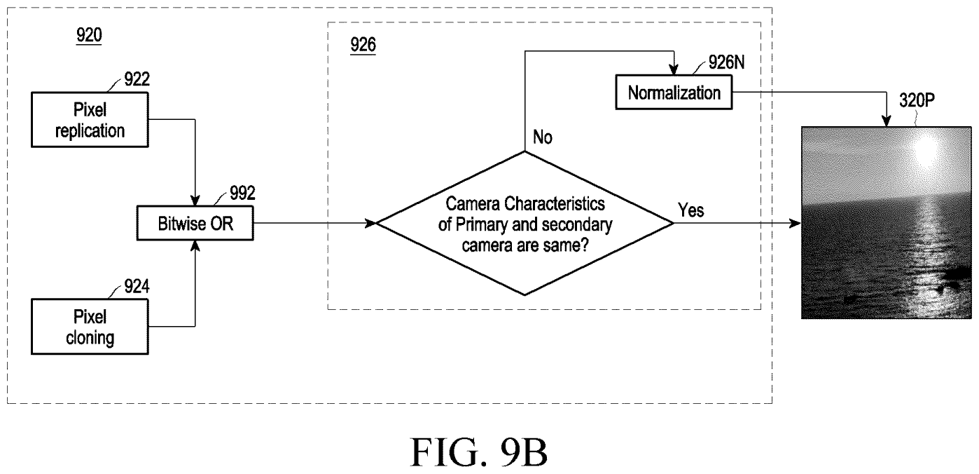

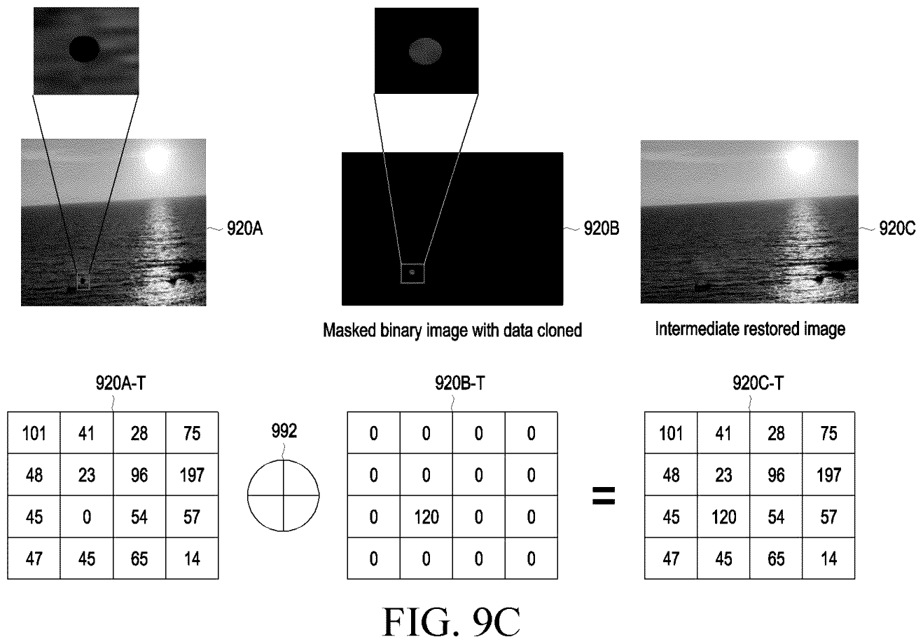

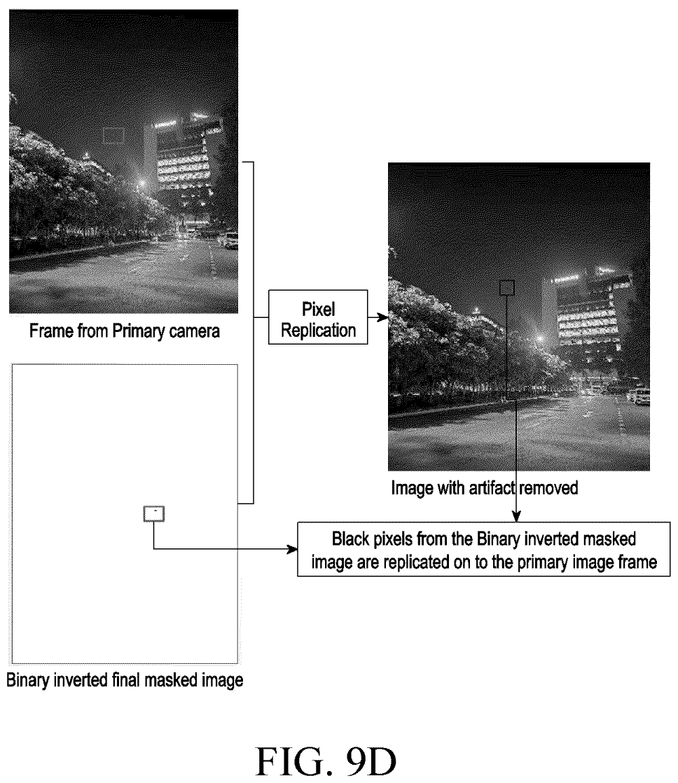

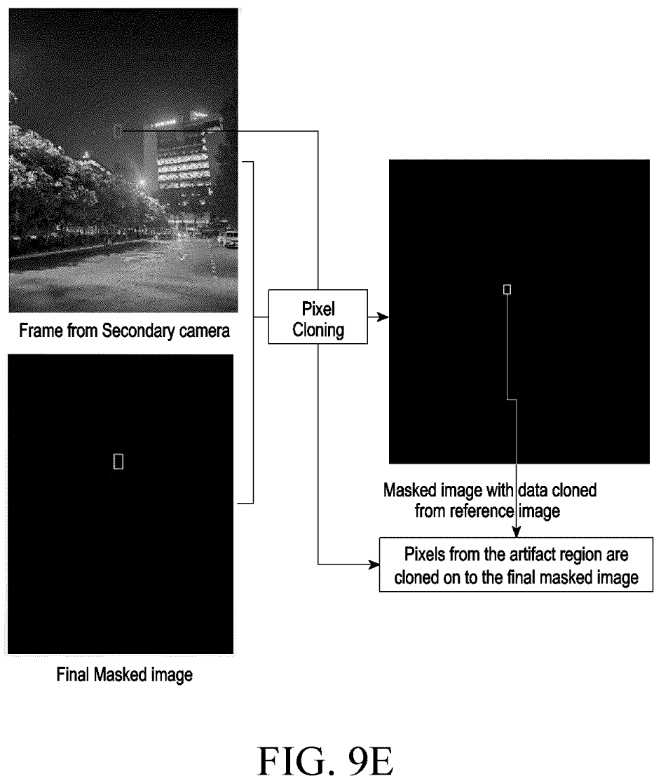

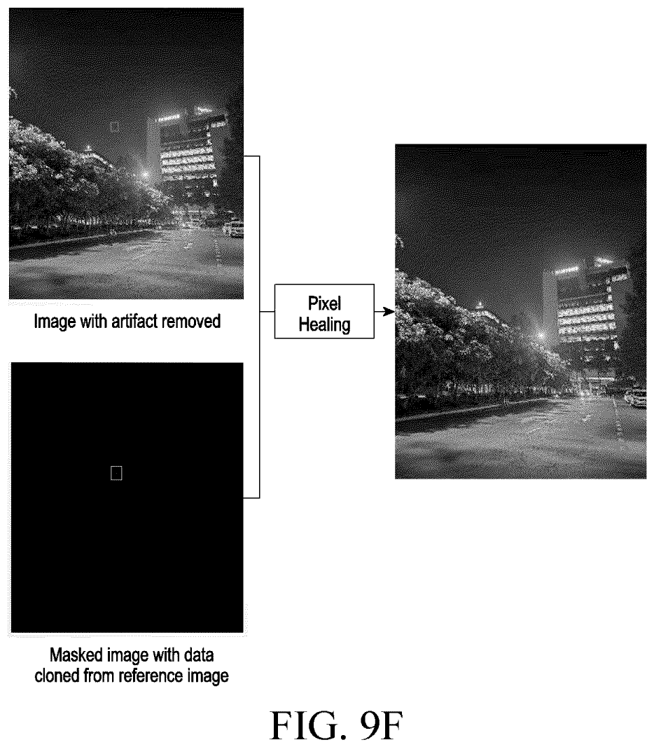

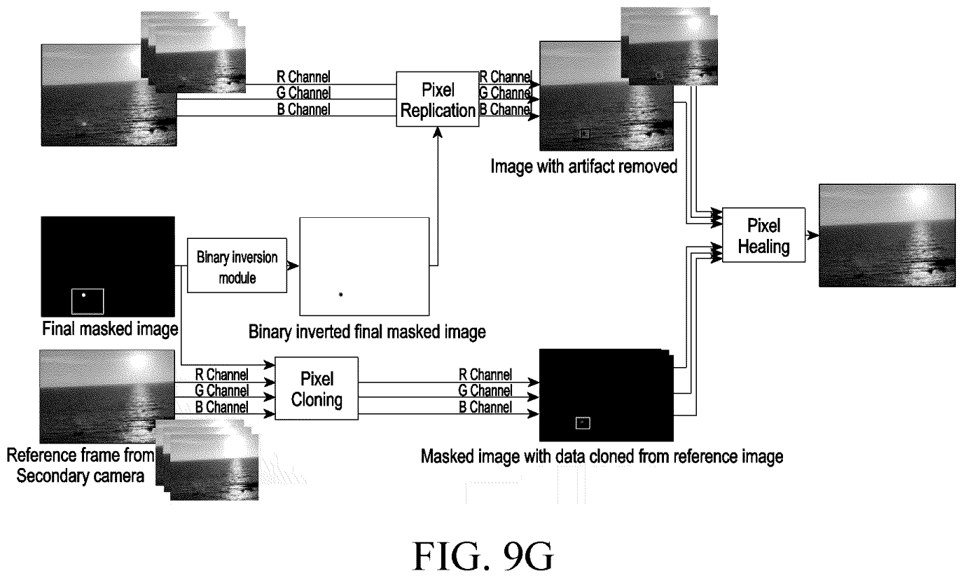

FIG. 9A illustrates the working of the LENS-AR module 450, in accordance with an embodiment. The LENS-AR module 450 is configured for applying the masked binary image 810 to the aligned second image 320-2A for extracting restoration data from the second image 320-2 and generating a restoration data mask based on the extracted restoration data. The LENS-AR module 450 is configured for applying the restoration data mask to the first image 320-1 for restoring lost data in the first image 320-1. The lost data is the data that is lost in the first image 320-1 due to the one or more artifacts 320BA. The LENS-AR module 450 is configured for generating the processed first image 320P with removed bubble artifact 320BA.

In an embodiment, the LENS-AR module 450 includes a binary inversion module 910 and a restoration engine 920. The restoration engine 920 includes a pixel replication module 922, a pixel cloning module 924, and a pixel healing module 926. The binary inversion module 910 is configured for generating an inverted masked binary image 910IV from the masked binary image 810. The replication module 922 is configured for replicating pixels of the inverted masked binary image 910IV onto the first image 320-1. The pixel cloning module 924 is configured for cloning pixels having the bubble artifacts 320BA from the aligned second image 320-2A onto the inverted masked binary image 910IV. Subsequently, the pixel healing module 926 superimposes the cloned pixels of the inverted masked binary image 910IV onto the replicated pixels in the first image 320-1 to get the processed image 320P, which is free of the bubble artifact 320BA.

FIGS. 9B-9C illustrate the working of the pixel replication module 922, the pixel cloning module 924 and the pixel healing module 926 of the restoration engine 920 of the LENS-AR module 450, in accordance with an embodiment. The pixel replication module 922 replaces the pixels at the location 320BA-L in the first image 320-1 with black pixels to get an image 920A (shown in FIG. 9C). The image 920A is the first image 320-1 having the bubble artifact 320BA replaced with black pixels. The pixel cloning module 924 clones the pixels at the location 320BA-L from the aligned second image 320-2A onto the inverted masked binary image 910IV to get an image 920B. Subsequently, the pixel healing module 926 superimposes the cloned pixels in the image 920B onto the image 920A to get the image 920C, which is free of the bubble artifact 320BA.

In an embodiment, the restoration engine 920 includes an operation 992. The operation 992 is a ‘Bitwise OR’ operation, represented by ‘1’. The operation 992 is performed on an overlap of the image 920A and the image 920B. The operation 992 replaces the black pixels in the image 920A with corresponding pixels from the image 920B to generate the image 920C. The operation 992 takes two numbers as operands and does an OR on every bit of two numbers. The result of the ‘OR’ is ‘1’ if any of the two bits is 1.

Referring now to FIG. 9C, for image 920A, the ‘0’ values in tables 920A-T, 920B-T, 920C-T (corresponding to the images 920A, 920B, 920C) represent black pixels and the values greater than ‘0’ values represent original image data as in the image 320-1.

The image 920B is subject to operation 992 (bitwise) with the black pixels in the image 920A. As a result of which, the black pixels in the image 920A will be replaced with the pixel data from the image 920B to generate the image 920C. The image 920C is the image 320-1 with the artifact removed since the data has now been restored from the aligned second image 320-2A.

It may be apparent that the exemplary embodiment of FIG. 9C is for a single channel and may be replicated for other split-channels such as the channel G and B.

In an embodiment, depending upon the difference in characteristics of the first camera 150-1 and the second camera 150-2, the image 920C may be normalized to get the final processed image 320P. The pixel healing module 926 includes a normalization module 926N. The normalization module 926N is configured for testing a condition whether the characteristics of the first and the second cameras 150-1 and 150-2 are same. If the condition is satisfied, the image 920C is the final processed image 320P. Else, if the characteristics of the first and the second cameras 150-1 and 150-2 are not the same the image 920C is passed through the normalization block 926N for generating the final processed image 320P.

FIG. 9D illustrates that an operation of pixel replication performed in the multi-camera device, in accordance with an embodiment. Referring FIG. 9D, a pixel replication module of FIG. 9D takes the inverted masked binary image and the primary camera frame as input and it fills the region of the artifact with the black pixels of the inverted masked binary image. The pixel replication module of FIG. 9D overlaps the primary camera frame and binary inverted masked image and the black pixels will overlap on the primary image frame on the artifact region. According to an embodiment, the pixel replication module of FIG. 9D masks the artifact region and extract out the lens reflection artifact from the image. According to an embodiment, the pixel replication module of FIG. 9D fills the data from the secondary frame because if the artifact is overlapped without filling the artifact region with black pixels then the pixel replication module of FIG. 9D cannot fill the region with the corresponding pixels from the secondary image.

FIG. 9E illustrates that an operation of pixel cloning performed in the multi-camera device, in accordance with an embodiment. According to an embodiment, a pixel cloning module of FIG. 9E takes the final masked image and the secondary camera frame as input and clones the artifact region of secondary frame to the final masked image. According to an embodiment, the pixel cloning module of FIG. 9E overlaps the secondary frame and the final masked image to overlap the pixels of corresponding artifact region pixels In the secondary frame. According to an embodiment, the pixel cloning module of FIG. 9E extracts the pixels of secondary frame from the corresponding artifact region and to fill the corresponding artifact region in the primary frame. According to this, the artifact region is filled with the secondary frame data and restore the image.

FIG. 9F illustrates that an operation of pixel healing performed in the multi-camera device, in accordance with an embodiment. FIG. 9G illustrates overall procedures for removing lens artifact, in accordance with an embodiment. According to an embodiment, a pixel healing module of the FIG. 9F fills the artifact region which was replicated by black pixels with the data cloned from the secondary frame to masked binary image. According to an embodiment, the pixel healing module of the FIG. 9F overlaps the masked image with the data cloned from secondary frame and primary frame with the artifact removed. According to an embodiment, this overlap will fill the data of the corresponding pixels in the secondary frame with artifact region of the primary frame to fill the data and restore the image. According to an embodiment, the black and white masks are ways to copy data to and from the primary and secondary frame. According to an embodiment, the pixel healing module of the FIG. 9F also may normalize the difference in lens characteristics in the artifact region when lens characteristics of the primary and secondary camera are different.

FIG. 10A illustrates the reason why at least one image captured by the secondary camera cannot be directly output. Refereeing to the FIG. 10A, there are two scenarios here, the artifact is present in only primary camera, and/or the artifact is present in both primary and secondary camera. According to an embodiment, the multi-camera device 150 may not identify whether the artifact is present in the secondary camera. According to an embodiment, the multi-camera device 150 may not crop to FOV of primary camera and output the secondary camera image because user has intended to capture from the primary camera and user selected camera should capture the image. According to an embodiment, another reason is because of the difference in lens characteristics (color, exposure, white balance, ISO, tuning parameters) are different from the user selected camera.

FIG. 10B and FIG. 10C illustrate lens reflection bubble artifact present in primary camera and secondary camera. Refereeing to the FIGS. 10B and 10C, According to an embodiment, the multi-camera device 150 may removing lens reflection bubble artifact from the first image, and display a third image removed the lens reflection bubble artifact.

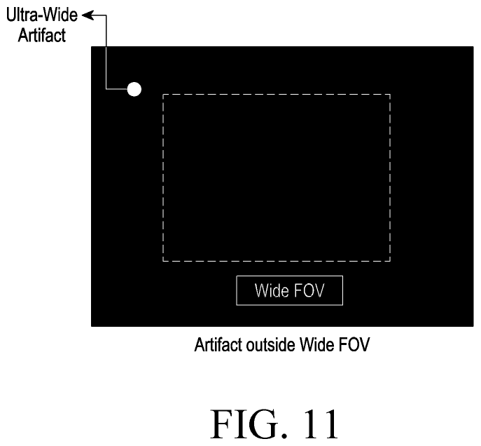

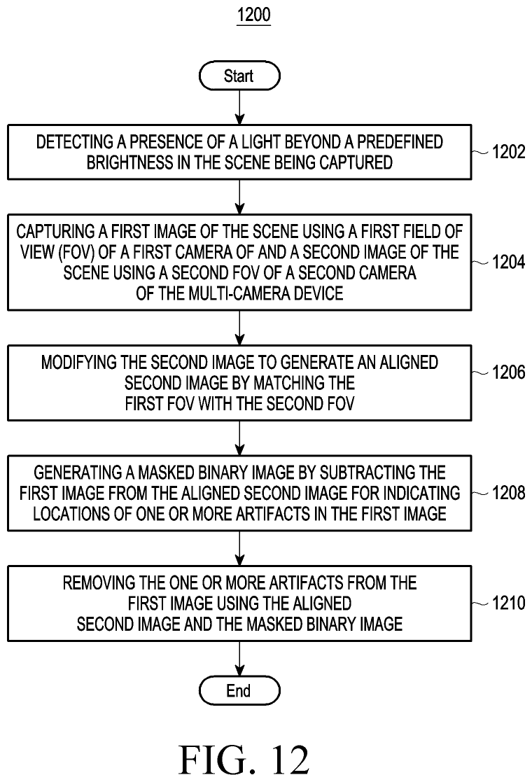

FIG. 11 illustrates the artifact formed is outside the FOV of the wide camera when the ultra-wide camera is the primary camera. According to an embodiment, when the ultra-wide camera is the primary camera and the artifact formed is outside the FOV of the wide camera then there exists no reference image to perform L-RAID because the FOV of wide camera covers only a part of the ultra-wide camera and the artifact is formed beyond the FOV of the wide camera. According to an embodiment, when such case occurs, the multi-camera device 150, using AI model (e.g., GAN) and/or in painting algorithms, removes the artifact. FIG. 12 is a flowchart illustrating a method 1200 for removing one or more artifacts 320BA from an image 320-1 of a scene 100-S being captured using the multi-camera device 150, in accordance with an embodiment.

Referring to FIGS. 3-11 together, the method 1200 may be performed by the device 150 such as a camera device having more than one camera, a camcorder, a mobile device with two or more cameras, a tab with similar capabilities, and the like based on instructions retrieved from non-transitory computer-readable media. A computer-readable medium may include machine-executable or computer-executable instructions to perform all or portions of the described method. The computer-readable media may be, for example, digital memories, magnetic storage media, such as magnetic disks and magnetic tapes, hard drives, or optically readable data storage media.

The method 1200 includes a series of operations shown at operation 1002 through operation 1210 of FIG. 12. The method 1200 may be performed by the system 310 in conjunction with one or more modules 510, the details of which are explained in conjunction with FIGS. 3-11. The method 1200 begins at operation 1202.

At operation 1202, the method 1200 includes detecting a presence of a light beyond a predefined brightness in the scene 100S being captured. For example, the multi-camera device 150 identifies that one or more artifacts are included in the scene 100S, when the presence of the light beyond the predefined brightness in the scene 100S.

At operation 1204, the method 1200 includes, based on the detecting of the presence of the light beyond the predefined brightness in the scene 100S being captured, capturing a first image 320-1 of the scene 100S using a first Field of View (FOV) of the first camera 150-1 of the multi-camera device 150, and the second image 320-2 of the scene 100S using a second FOV of the second camera 150-2 of the multi-camera device 150.

At operation 1206, the method 1200 includes modifying the second image 320-2 to generate the aligned second image 320-2A by matching the first FOV with the second FOV.

At operation 1208, the method 1200 includes generating the masked binary image 810 by subtracting the first image 320-1 from the aligned second image 320-2. The masked binary image 810 indicates locations of one or more artifacts 320BA in the first image 320-1.

At operation 1210, the method 1200 includes outputting (e.g., displaying) a third image generated by removing the one or more artifacts 320BA from the first image 320-1 using the aligned second image 320-2A and the masked binary image 810.

The third image may be output via a display of the system 310 or device 150.

The third image may be stored in memory of the system 310 or device 150.

The third image may be transmitted to another device a network interface of the system 310 or device 150. The method 1200, at operation 1202, includes evaluating the light in the frames of the first camera 150-1. The capturing of the second image 320-2 is performed in response to the evaluation of the light.

The method 1200 further includes comparing FOVs of a plurality of cameras in the multi-camera device 150 and selecting, from the plurality of cameras, a camera having an FOV different from the first FOV as the second camera 150-2. The matching of the first FOV with the second FOV is based on at least one of a positional difference, in the multi-camera device 150, of the first camera 150-1 and the second camera 150-2, and a relative optical zoom between the first camera 150-1 and the second camera 150-2.

The method 1200, at operation 1208, includes generating a grayscale mask frame by splitting each of the first image 320-1 and the second image 320-2 into a plurality of color channels, and calculating, for each color channel, a pixel-wise difference between corresponding color channels of the first image 320-1 and the second image 320-2. The method 1000 further includes generating the masked binary image by applying dynamic thresholding to the grayscale mask frame. The dynamic thresholding is applied based on an average lux value of the first image.

The method 1200, at operation 1210, further includes applying the masked binary image 810 to the aligned second image 320-2A for extracting restoration data from the second image 320-2 and generating a restoration data mask based on the extracted restoration data. The method 1000, at operation 1010, further includes applying the restoration data mask to the first image 320-1 for restoring lost data in the first image 320-1, the lost data being data lost in the first image 320-1 due to the one or more artifacts 320BA.

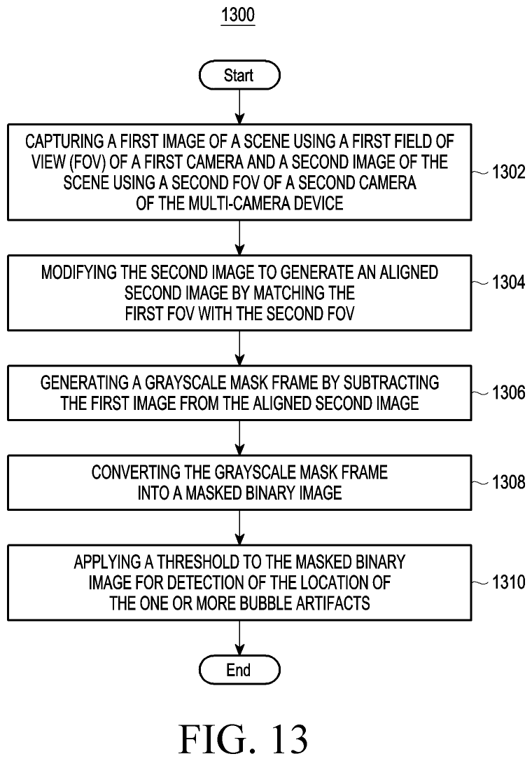

FIG. 13 is a flowchart illustrating a method 1300 for detection of locations of one or more bubble artifacts 320BA in an image in the multi-camera device 150 in accordance with an embodiment.

Referring to FIGS. 3-12 together, the method 1300 may be performed by the device 150 such as a camera device having more than one camera, a camcorder, a mobile device with two or more cameras, a tab with similar capabilities, and the like based on instructions retrieved from non-transitory computer-readable media. A computer-readable media may include machine-executable or computer-executable instructions to perform all or portions of the described method. The computer-readable media may be, for example, digital memories, magnetic storage media, such as magnetic disks and magnetic tapes, hard drives, or optically readable data storage media.

The method 1300 includes a series of operations shown at operation 1302 through operation 1310 of FIG. 11. The method 1300 may be performed by the system 310 in conjunction with one or more modules 510, the details of which are explained in conjunction with FIGS. 3-12. The method 1300 begins at operation 1302.

At operation 1302, the method 1300 includes capturing the first image 320-1 of the scene 100S using a first Field of View (FOV) of a first camera 150-1 of the multi-camera device 150, and the second image 320-2 of the scene 100S using a second FOV of the second camera 150-2 of the multi-camera device 150, wherein the first FOV is different from the second FOV.

At operation 1304, the method 1300 includes modifying the second image 320-2 to generate an aligned second image 320-2A by matching the first FOV with the second FOV. At operation 1306, the method 1300 includes generating a grayscale mask frame by subtracting the first image 320-1 from the aligned second image 320-2A. At operation 1308, the method 1300 includes converting the grayscale mask frame into a masked binary image 810. At operation 1310, the method 1300 includes applying a threshold to the grayscale mask frame to generate the masked binary image 810 for detection of the location of the one or more bubble artifacts 320BA.

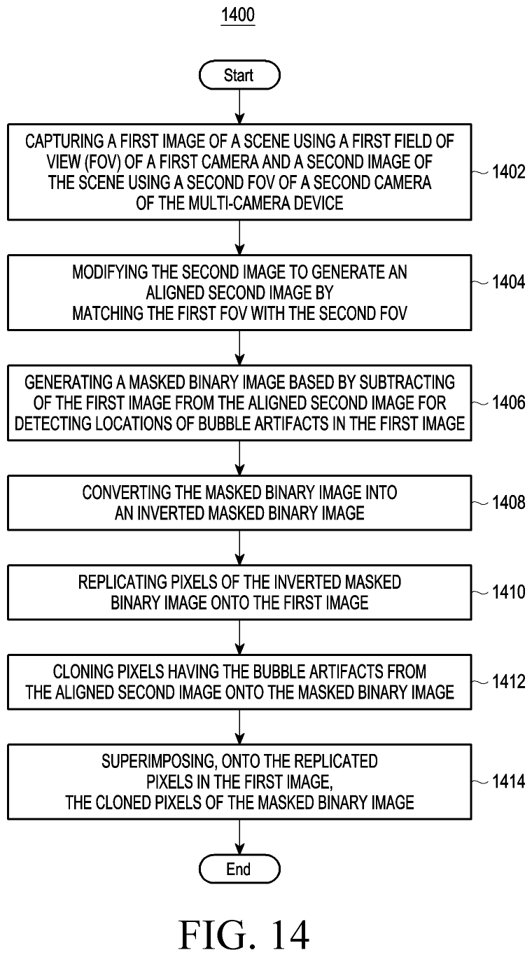

FIG. 14 is a flowchart illustrating a method 1400 for removing bubble artifacts 320BA in an image 320-1 in the multi-camera device 150, in accordance with an embodiment.

Referring to FIGS. 3-13 together, the method 1400 may be performed by the device 150 such as a camera device having more than one camera, a camcorder, a mobile device with two or more cameras, a tab with similar capabilities, and the like based on instructions retrieved from non-transitory computer-readable media. A computer-readable media may include machine-executable or computer-executable instructions to perform all or portions of the described method. The computer-readable media may be, for example, digital memories, magnetic storage media, such as magnetic disks and magnetic tapes, hard drives, or optically readable data storage media.

The method 1400 includes a series of operations shown at operation 1402 through operation 1414 of FIG. 14. The method 1400 may be performed by the system 310 in conjunction with one or more modules 510, the details of which are explained in conjunction with FIGS. 3-9. The method 1400 begins at operation 1402.

At operation 1402, the method 1400 includes capturing the first image of a scene using the first Field of View (FOV) of the first camera of the multi-camera device, and the second image of the scene using a second FOV of the second camera of the multi-camera device, wherein the first FOV is different from the second FOV. At operation 1404, the method 1400 includes modifying the second image to generate an aligned second image by matching the first FOV with the second FOV. At operation 1406, the method 1400 includes generating, for detecting locations of the bubble artifacts in the first image, a masked binary image based by subtracting of the first image from the aligned second image. At operation 1408, the method 1400 includes converting the masked binary image into an inverted masked binary image. At operation 1410, the method 1400 includes replicating pixels of the inverted masked binary image onto the first image. At operation 1412, the method 1400 includes cloning pixels having the bubble artifacts from the aligned second image onto the masked binary image. At operation 1414, the method 1400 includes superimposing, onto the replicated pixels in the first image, the cloned pixels of the masked binary image.

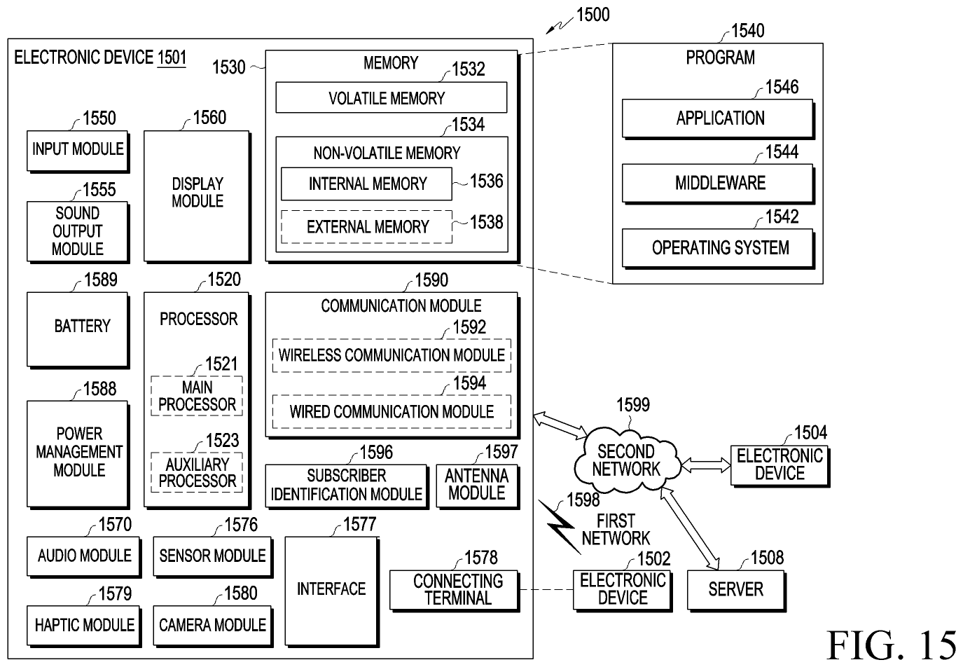

FIG. 15 is a block diagram illustrating an electronic device 1501 in a network environment 1500 according to various embodiments. Referring to FIG. 15, the electronic device 1501 (e.g., the multi-camera device 150) in the network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module (SIM) 1596, or an antenna module 1597. In some embodiments, at least one of the components (e.g., the connecting terminal 1578) may be omitted from the electronic device 1501, or one or more other components may be added in the electronic device 1501. In some embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to one embodiment, as at least part of the data processing or computation, the processor 1520 may store a command or data received from another component (e.g., the sensor module 1576 or the communication module 1590) in volatile memory 1532, process the command or the data stored in the volatile memory 1532, and store resulting data in non-volatile memory 1534. According to an embodiment, the processor 1520 may include a main processor 1521 (e.g., a central processing unit (CPU) or an application processor (AP)), or an auxiliary processor 1523 (e.g., a graphics processing unit (GPU), a neural processing unit (NPU), an image signal processor (ISP), a sensor hub processor, or a communication processor (CP)) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521.

The auxiliary processor 1523 may control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an image signal processor or a communication processor) may be implemented as part of another component (e.g., the camera module 1580 or the communication module 1590) functionally related to the auxiliary processor 1523. According to an embodiment, the auxiliary processor 1523 (e.g., the neural processing unit) may include a hardware structure specified for artificial intelligence model processing. An artificial intelligence model may be generated by machine learning. Such learning may be performed, e.g., by the electronic device 1501 where the artificial intelligence is performed or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to an embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550, or output the sound via the sound output module 1555 or a headphone of an external electronic device (e.g., an electronic device 1502) directly (e.g., wiredly) or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly (e.g., wiredly) or wirelessly. According to an embodiment, the interface 1577 may include, for example, a high definition multimedia interface (HDMI), a universal serial bus (USB) interface, a secure digital (SD) card interface, or an audio interface.

A connecting terminal 1578 may include a connector via which the electronic device 1501 may be physically connected with the external electronic device (e.g., the electronic device 1502). According to an embodiment, the connecting terminal 1578 may include, for example, a HDMI connector, a USB connector, a SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image or moving images. According to an embodiment, the camera module 1580 may include one or more lenses, image sensors, image signal processors, or flashes.

The power management module 1588 may manage power supplied to the electronic device 1501. According to one embodiment, the power management module 1588 may be implemented as at least part of, for example, a power management integrated circuit (PMIC).

The battery 1589 may supply power to at least one component of the electronic device 1501. According to an embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the application processor (AP)) and supports a direct (e.g., wired) communication or a wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module or a power line communication (PLC) module). A corresponding one of these communication modules may communicate with the external electronic device via the first network 1598 (e.g., a short-range communication network, such as Bluetooth™, wireless-fidelity (Wi-Fi) direct, or infrared data association (IrDA)) or the second network 1599 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The wireless communication module 1592 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., the mmWave band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1597 may transmit or receive a signal or power to or from the outside (e.g., the external electronic device) of the electronic device 1501. According to an embodiment, the antenna module 1597 may include an antenna including a radiating element composed of a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 (e.g., the wireless communication module 1592) from the plurality of antennas. The signal or the power may then be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to various embodiments, the antenna module 1597 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1501 and the external electronic device 1504 via the server 1508 coupled with the second network 1599. Each of the electronic devices 1502 or 1504 may be a device of a same type as, or a different type, from the electronic device 1501. According to an embodiment, all or some of operations to be executed at the electronic device 1501 may be executed at one or more of the external electronic devices 1502, 1504, or 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, a cloud computing, distributed computing, mobile edge computing (MEC), or client-server computing technology may be used, for example. The electronic device 1501 may provide ultra low-latency services using, e.g., distributed computing or mobile edge computing. In another embodiment, the external electronic device 1504 may include an internet-of-things (IoT) device. The server 1508 may be an intelligent server using machine learning and/or a neural network. According to an embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). For example, a processor (e.g., the processor 1520) of the machine (e.g., the electronic device 1501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The system and method may use the difference in the location of the bubble Artifact 320BA in the two cameras of the multi-camera device. Since the physical location of cameras is different, the bubble artifact appears at different location in the two images, and one may be used to restore the other.

The method may be accurate and eliminates distortion in the original image. The method does not use image editing applications and is not time-consuming or effort intensive. The method is also not dependent upon human skill or art of editing image.

Since the location of the bubble artifact is accurately determined and the data is restored from an image of the same scene, the restored image appears as if the bubble never existed and even the preview of the camera may be able to eliminate the bubble. Hence, the user is free to choose the composition of the frame without worrying about the bright source in the vicinity. The quality of restoration is better as the data is taken from a reference camera and not done using in-painting

While language has been used to describe the disclosure, any limitations arising on account of the same are not intended. As would be apparent to a person in the art, various working modifications may be made to the method in order to implement the concepts taught herein.

The drawings and the forgoing description give examples of embodiments. Those skilled in the art will appreciate that one or more of the described elements may well be combined into a single functional element. Elements may be split into multiple functional elements. Elements from one embodiment may be added to another embodiment. For example, orders of processes described herein may be changed and are not limited to the manner described herein.

Moreover, the actions of any flow diagram need not be implemented in the order shown. Those acts that are not dependent on other acts may be performed in parallel with the other acts. The scope of embodiments is by no means limited by these examples. Numerous variations, whether explicitly given, such as differences in structure, dimension, and use of material, are within the scope of the disclosure.

Benefits, other advantages, and solutions to problems have been described above with regard to embodiments. The benefits, advantages, solutions to problems, and any component(s) that may cause any benefit, advantage, or solution to occur or become more pronounced are not to be construed as a critical, required, or essential feature or component of any or all the claims.

What is claimed is:

1. A method for controlling an electronic device, comprising:
detecting a light source in at least one image frame captured by at least one camera among a plurality of cameras of the electronic device;
determining whether a brightness of the light source is more than a threshold value for the brightness,
based on the brightness of the light source is more than the threshold value, obtaining a first image using a first camera with a first Field of View (FOV) among the plurality of cameras, and a second image using a second camera with a second FOV among the plurality of cameras;
generate an aligned second image by aligning the first image and the second image based on the first FOV with the second FOV;
generating a masked binary image by subtracting the first image from the aligned second image, wherein the masked binary image indicates one or more locations of one or more artifacts in the first image;
removing the one or more artifacts from the first image by using the aligned second image and the masked binary image, and generating a third image that the one or more artifacts from the first image are removed, and
displaying, through a display of the electronic device, the third image.

2. The method as claimed in claim 1, wherein the detecting the light source comprises:
evaluating the light in one or more frames of the first camera, wherein the capturing the second image is performed in response to the evaluating the light.

3. The method as claimed in claim 1, further comprising:
comparing FOVs of the plurality of cameras of the electronic device; and
selecting, from among the plurality of cameras, a camera having an FOV different from the first FOV as the second camera.

4. The method as claimed in claim 1, wherein the modifying the second image to generate the aligned second image comprises matching the first FOV with the second FOV based on at least one of:
a positional difference, in the electronic device, of the first camera and the second camera, or
a relative optical zoom between the first camera and the second camera.

5. The method as claimed in claim 1, wherein the generating the masked binary image comprises generating a grayscale mask frame by:
splitting each of the first image and the second image into a plurality of color channels; and
calculating, for the plurality of color channels, a pixel-wise difference between corresponding color channels of the first image and the second image.

6. The method as claimed in claim 5, wherein the generating the masked binary image comprises applying dynamic thresholding to the grayscale mask frame based on an average lux value of the first image.

7. The method as claimed in claim 5, wherein the removing the one or more artifacts comprises:
applying the masked binary image to the aligned second image;
extracting restoration data from the second image; and
generating a restoration data mask based on the restoration data.

8. The method as claimed in claim 7, wherein the removing the one or more artifacts comprises applying the restoration data mask to the first image for restoring lost data in the first image, the lost data being data lost in the first image due to the one or more artifacts.

9. The method as claimed in claim 3, wherein the selecting the second camera comprises:
loading an FOV matching table comprising a plurality of camera IDs and a plurality of FOV values corresponding to the plurality of cameras; and
selecting the second camera from among the plurality of cameras based on the plurality of camera IDs and the plurality of FOV values.

10. An electronic device, comprising:
a plurality of cameras;
one or more processors; and
memory storing instructions that, when executed by the one or more processors, cause the multi-camera device to:
detect a light source in at least one image frame captured by at least one camera among the plurality of cameras of the electronic device;
determine whether a brightness of the light source is more than a threshold value for the brightness,
based on the brightness of the light source is more than the threshold value, obtain a first image using a first camera with a first View (FOV) among the plurality of cameras, and a second image using a second camera with a second FOV among the plurality of cameras;
generate an aligned second image by aligning the first image and the second image based on the first FOV with the second FOV;
generate a masked binary image by subtracting the first image from the aligned second image, wherein the masked binary image indicates one or more locations of one or more artifacts in the first image,
remove the one or more artifacts from the first image by using the aligned second image and the masked binary image, and generate a third image that the one or more artifacts from the first image are removed, and
display, through a display of the electronic device, the third image.

11. The electronic device as claimed in claim 10, wherein the instructions, when executed by the one or more processors, cause the electronic device to evaluate the light in one or more frames of the first camera, wherein the second image is captured, via the second camera, in response to the light being evaluated.

12. The electronic device as claimed in claim 10, wherein the instructions, when executed by the one or more processors, cause the electronic device to:
compare FOVs of the plurality of cameras; and
select, from among the plurality of cameras, a camera having an FOV different from the first FOV as the second camera.

13. The electronic device as claimed in claim 10, wherein the instructions, when executed by the one or more processors, cause the electronic device to match the first FOV with the second FOV based on at least one of:
a positional difference, in the multi-camera device, of the first camera and the second camera, and
a relative optical zoom between the first camera and the second camera.

14. The electronic device as claimed in claim 10, wherein the instructions, when executed by the one or more processors, cause the electronic device to generate the masked binary image based on generating a grayscale mask frame, and
wherein the grayscale mask frame is generated based on:
splitting each of the first image and the second image into a plurality of color channels; and
calculating, for the plurality of color channels, a pixel-wise difference between corresponding color channels of the first image and the aligned second image.

15. The electronic device as claimed in claim 14, wherein the instructions, when executed by the one or more processors, cause the electronic device to apply a dynamic threshold to the grayscale mask frame based on an average lux value of the first image.

16. The electronic device as claimed in claim 10, wherein the instructions, when executed by the one or more processors, cause the electronic device to:
apply the masked binary image to the aligned second image;
extract restoration data from the second image; and
generate a restoration data mask based on the restoration data.

17. The electronic device as claimed in claim 16, wherein the instructions, when executed by the one or more processors, cause the electronic device to apply the restoration data mask to the first image for restoring lost data in the first image, the lost data being data lost in the first image due to the one or more artifacts.

18. A non-transitory computer-readable recording medium having instructions recorded thereon, that, when executed by one or more processors of the electronic device, cause the electronic device to:
detect a light source in at least one image frame captured by at least one camera among the plurality of cameras of the electronic device;
determine whether a brightness of the light source is more than a threshold value for the brightness,
based on the brightness of the light source is more than the threshold value, obtain a first image using a first camera with a first View (FOV) among the plurality of cameras, and a second image using a second camera with a second FOV among the plurality of cameras;
generate an aligned second image by aligning the first image and the second image based on the first FOV with the second FOV;
generate a masked binary image by subtracting the first image from the aligned second image, wherein the masked binary image indicates one or more locations of one or more artifacts in the first image,
remove the one or more artifacts from the first image by using the aligned second image and the masked binary image, and generate a third image that the one or more artifacts from the first image are removed, and
display, through a display of the electronic device, the third image.

19. The non-transitory computer-readable recording medium as claimed in claim 18, wherein the instructions, when executed by the one or more processors, cause the electronic device to evaluate the light in one or more frames of the first camera, wherein the second image is captured, via the second camera, in response to the light being evaluated.

20. The non-transitory computer-readable recording medium as claimed in claim 18, wherein the instructions, when executed by the one or more processors, cause the electronic device to:
compare FOVs of the plurality of cameras; and
select, from among the plurality of cameras, a camera having an FOV different from the first FOV as the second camera.
